(19) United States
(12) Patent Application Publication
(10) Pub. No.: US 2015/0302486 A1
(43) Pub. Date: Oct. 22, 2015

(54) MULTIPLE PARTY ADVERTISEMENT SYSTEM AND METHOD

(71) Applicants: Christopher T. FOUFAS, Lake Forest, IL (US); Tanatphol CHANTHAROJWONGSE, Skokie, IL (US); John MIX, III, Denver, CO (US); Phillip USHIJIMA, Mokena, IL (US)

(72) Inventors: Christopher T. FOUFAS, Lake Forest, IL (US); Tanatphol CHANTHAROJWONGSE, Skokie, IL (US); John MIX, III, Denver, CO (US); Brooke S. NANBERG FOLEY, Highland Park, IL (US); Phillip USHIJIMA, Mokena, IL (US)

(21) Appl. No.: 13/813,137

(22) PCT Filed: Jul. 29, 2011
(86) PCT No.: PCT/US2011/046012

§ 371 Date: Jun. 30, 2015

Related U.S. Application Data
(60) Provisional application No. 61/369,066, filed on Jul. 29, 2010.
(60) Provisional application No. 61/384,168, filed on Sep. 17, 2010.
(60) Provisional application No. 61/392,004, filed on Oct. 11, 2010.
(60) Provisional application No. 61/409,427, filed on Nov. 2, 2010.
(60) Provisional application No. 61/438,907, filed on Feb. 2, 2011.

(51) Int. Cl. G06Q 30/02

(52) U.S. Cl. CPC G06Q 30/0277; G06Q 30/0224; G06Q 30/0272; G06Q 30/0273

(57) ABSTRACT

A multiple party advertisement system and method for operation are disclosed. The system provides a medium for sponsors to sell products or services to users who purchase discount spaces within an electronic discount board viewable over a network in return for a discount offer such as a coupon. In some embodiments, the user may submit content that the system displays on the purchased discount space. The discount board is associated with one or more future events that will produce a certain alphanumeric result that can be used to identify a resultant discount space for purposes of distributing the sponsored good or service to the user that purchased the resultant discount space. Additional incentives and social media features to increase viewership and participation are disclosed.

### CROSS-REFERENCE TO RELATED APPLICATIONS

This application is a national stage patent application of PCT/US2011/46012, filed on Jul. 29, 2011, which claims priority to U.S. Patent Application No. 61/369066 filed on Jul. 29, 2010; U.S. Patent Application No. 61/384168 filed on Sep. 17, 2010; U.S. Patent Application No. 61/392004 filed on Oct. 11, 2010; U.S. Patent Application No. 61/409427 filed on Nov. 2, 2010; and U.S. Patent Application No. 61/438907 filed on Feb. 2, 2011, all of which are incorporated herein by reference in their entirety.

### TECHNICAL FIELD

This invention relates generally to systems and methods for Internet advertising and sales of goods and services, and more specifically, to systems and methods for displaying advertisements submitted from multiple parties in a manner and environment that will encourage viewership and participation.

### BACKGROUND OF THE INVENTION

As the Internet has evolved, traditional advertising mediums such as television and radio are no longer as likely to reach certain demographics. Companies and their marketing teams continue to look for new and innovative ways to reach these consumers. The Internet is now filled with advertising, most usually in the form of click-through advertisements such as those found on mainstream websites like Yahoo.com or ESPN.com. On a given webpage associated with such websites, the content the visitor has sought out (such as an article, stock quote, sports score, etc.) will be featured generally in the center of the webpage while the periphery may obtain one or more separately generated advertisements. Most of these advertisements are of the “click-through” variety. A typical click-through advertisement contains an embedded hyperlink such that, when the advertisement is clicked on by the webpage visitor, the visitor's Internet browser will redirect to a website associated with the advertising party. A tally is kept for each time a given advertisement is clicked-on, and this tally is used to formulate the bill to company placing the ad. In many cases, there is no cost to post the ad. Rather, the advertising party pays a set fee each time its advertisement is clicked on. Because of technology such as cookies and other usage recording devices, systems have developed that can monitor the usage patterns of visitors and use this information to select advertising catered to specific visitors. This concept is generally referred to as targeted advertising.

In another advertising model that has evolved on the Internet, the advertising is the content being sought out. One form of this concept is set forth in the background of U.S. Pat. Publication No. 2008/0040228 A1 (“Gutierrez”). Gutierrez describes the concept of advertisers buying “pixel blocks”, or space, on a webpage that features nothing but these pixel blocks decorated by different purchasers. In essence, a webpage consists of a finite amount of real estate defined by a generally rectangular field of pixels that produce a screen image. In a “pixel site”, as described by Gutierrez, this rectangular pattern is divided up into a number of discreet pixel blocks that can house individual content. Each pixel block is purchased by an advertising party, who submits content to fill the pixel block. This produces a webpage which is a giant patchwork of advertisements submitted from various parties. Because the pixel blocks are of limited space, the advertisements may be nothing more than a logo or symbol, possibly with an embedded hyperlink. Essentially, the submitted advertisements are the content of a pixel site. Beyond the advertisements, there is no additional content, participatory function, membership or subscription opportunity, social networking opportunity, user advertising function, or any other interactive draw to attract users, visitors and prospective users to the website or any webpage within the website. While the “pixel site” concept was initially successful due to man's inherent curiosity, Gutierrez points out the need for other differing, variable, and dynamic incentives and function to build user enrollment and participation, visitor and user traffic, and new advertisers or sponsors. With no such additional content or user functions, the “pixel sites” Gutierrez describes soon lost their audience, and hence their value.

Gutierrez proceeds to describe an incentive program for a pixel site whereby “prizes” are awarded to visitors based on the pixel location where they click within a given webpage. These locations are recorded by a software application supporting the webpage, and a winning pixel location is selected randomly. The random selection of the winning pixel location may be tied to a sporting event or any pre-defined event that will result in numbers allowing for the identification of a specific pixel location.

There are many deficiencies and problems with the system disclosed within Gutierrez. While such a system very well might draw users to the pixel site, their incentive would only be to win the “prize”. Essentially, Gutierrez encourages visitors to randomly click all over the site as many times as possible. Creating multiple entries is as easy as creating multiple email addresses—a process that takes almost no time at all. While this might cause a visitor's browser to repeatedly redirect to websites operated by the advertisers, the incentive would then be for the visitor to immediately return to the pixel site, log in as another user, and click somewhere else in the field. The Gutierrez system also presents the potential for producing multiple winners, all of whom selected the winning pixel location. The present invention, however, overcomes at least these limited incentive problems posed by Gutierrez.

### SUMMARY OF THE INVENTION

In certain embodiments, the present invention comprises a multiple party advertising and sales system that can be used to create a dynamic internet social networking environment for displaying advertisements from multiple parties, such as a sponsor and a plurality of secondary advertisers, to a plurality of registered users (or simply users, if they have not yet registered for payment). In some embodiments, these registered users may also present advertisements, in which case they are referred to as participant advertisers. Sponsors are persons or entities interested in advertising and selling goods and services through the internet or over a network who choose to do so by sponsoring an advertising area associated with a particular webpage constructed by the system. In certain embodiments, as will be seen, the advertising area may be referred to as the discount board. Depending on the particular embodiment, participant advertisers or registered users are such persons or entities that wish to enroll or subscribe as users of the system in order to purchase a coupon or stored value card at a discounted rate, to have an opportunity to receive the sponsored goods or services, to advertise and promote their own products, businesses, causes or social messages, or to partake in advertising revenue and business opportunities which may be available as a result of commercial activity linked to the sponsored webpage with which they choose to participate. Secondary advertisers are persons and entities who wish to place advertisements and links on the sponsored webpage geared toward participant advertisers and visitors to the sponsored webpage. Visitors are any persons utilizing the internet to view the sponsored webpage, and could include sponsors, participant advertisers and registered users, or secondary advertisers wishing to monitor the activity or content of the sponsored webpage. The webpage, and the website in which it is housed, is managed by a system host. The environment created by the methods described provide for a highly variable and dynamic combination of financial, entertainment and psycho-social incentives for membership, participation and viewership that solve the problems experienced in the prior art.

In one embodiment, the advertisement system provides an advertising area comprised of a plurality of advertising spaces defined by first and second axes. Each advertising space within the advertising area may house individual advertisements submitted by participant advertisers who pay a price to the sponsor or system host in return for a posting of the advertisement. Participant advertisers may also receive revenue from secondary advertisements which are submitted by secondary advertisers and posted along the periphery of the advertising area. In addition, participant advertisers may receive coupons, stored value cards, or other valuable consideration for the purchase of an advertising space.

In an alternative embodiment, the advertising area is referred to as a discount board, and is comprised of a plurality of discount spaces defined by first and second axes. Each discount space corresponds to a discounted coupon or stored value card that has a fixed value for a set time at a given retailer. The retailer may or may not be the sponsor. After the set time, the fixed value resets to the price paid for the discount space. In some cases registered users may submit images or text to be placed on the discount space once purchased.

The advertising area or discount board is typically associated with a future event and a sponsored good or service, which will typically be provided by an identified sponsor or directly by the system host. The future event is such that it will produce a discreet alphanumeric result for use in identifying a single advertising space or discount space within the advertising area or discount board as the resultant advertising space or resultant discount space. The participant advertiser or registered user who purchased the resultant advertising space or resultant discount space is then entitled to receive the sponsored good or service. In lieu of a future event, a resultant advertising space or resultant discount space may be determined by a random number generation process. As disclosed herein, this invention has been developed so as to be manifested over the Internet.

In a particular embodiment, the invention comprises a computer readable medium for facilitating the placement of advertising by participant advertisers within an advertising area, comprising: logic for transmitting to a first remote computer sponsored good or service data prompts for receiving sponsored good or service data identifying a sponsored good or service; logic for receiving from the first remote computer the sponsor sponsored good or service data identifying the sponsored good or service for the advertising area; logic for associating the sponsored good or service data with the advertising area; logic for transmitting to a second remote computer the advertising area having a plurality of advertising spaces defined by first locations along a first axis and second locations along a second axis; logic for transmitting to the second remote computer a sponsored good or service identifier comprised within the sponsored good or service data and associated with the advertising area; logic for transmitting to the second computer advertising space data prompts for receiving advertising space data for at least one advertising space; logic for receiving from the second computer advertising space data for the at least one advertising space; logic for transmitting to a third remote computer secondary advertising data prompts for receiving secondary advertising data; logic for receiving from the third remote computer the secondary advertising data for generating advertising revenue associated with the advertising area; logic for determining a calculated advertising revenue amount based on the advertising revenue; logic for crediting the calculated advertising revenue amount to at least one of the participant advertisers; logic for determining, based on an outcome of a future event, a resultant advertising space defined by the first and second axis; logic for identifying a participant advertiser associated with the resultant advertising space to facilitate distribution of the sponsored good or service.

In another embodiment, the invention comprises a system for facilitating the placement of advertising by participant advertisers within an advertising area having a plurality of advertising spaces defined by first locations along a first axis and second locations along a second axis. The system comprises a computer memory for receiving from a plurality of remote computers and storing sponsored good or service data identifying a sponsored good or service for association with the advertising area, advertising space data for at least one advertising space, secondary advertising data for generating advertising revenue associated with the advertising area. The system also comprises a processor for associating the sponsored good or service data with the advertising area, for transmitting to a remote computer the advertising area and a sponsored good or service identifier comprised within the sponsored good or service data and associated with the advertising area, for determining a calculated advertising revenue amount based on the advertising revenue, for crediting the calculated advertising revenue amount to at least one of the participant advertisers, for determining, based on an outcome of an event, a resultant advertising space from among the plurality of advertising spaces, and for identifying the participant advertiser associated with the resultant advertising space for the purpose of assigning the sponsored good or service.

In yet another embodiment, the invention comprises a method of multiple party advertising, the method comprising the steps of: displaying on a host webpage an advertising area having two axes that define a plurality of advertising spaces, the advertising area associated with one or more future events that will produce a definite alphanumeric result capable of identifying a specific resultant advertising space; receiving to a host computer sponsored good or service data from a sponsor computer, the sponsored good or service data defining a digital image of a product or service offered by the sponsor; displaying the digital image on the host webpage; receiving to the host computer data from a participant advertiser computer participant advertiser data identifying one or more specific advertising spaces and providing content relating to the participant advertiser; displaying on the webpage on the one or more specific advertising spaces identified by the participant advertiser the content relating to the participant advertiser; receiving to the host computer secondary advertiser data from a secondary advertiser computer, the secondary advertiser data defining a secondary advertisement; displaying the secondary advertisement on the host website outside of the advertising area, and distributing at least a portion of the revenue generated therefrom to the participant advertiser; and displaying a deadline on the host website outside of the advertising area, after which no additional participant advertiser data will be received.

In some cases, the method set forth in the preceding paragraph may also comprise additional steps such as, for example: assigning to the sponsor advertising spaces not displaying content relating to a participant advertiser as of the deadline; processing the result of the at least one future event or random number generation to determine the resultant advertising space; distributing the product or service depicted in the digital image to the participant advertiser having selected and purchased the resultant advertising space; removing the digital image of the advertising area from the host webpage if a pre-defined number of advertising spaces do not display content relating to a participant advertiser as of the deadline; distributing a refund to the participant advertiser from whom was received the participant advertiser data; determining if a pre-defined number of advertising spaces display content relating to a participant advertiser as of the deadline, and, if so, processing the result of the at least one future event to determine the resultant advertising space; distributing the product or service depicted in the digital image to the participant advertiser having selected and purchased the resultant advertising space; assigning alphanumeric designators to locations along the first and second axes after the deadline, but prior to the completion of the one or more future events, the alphanumeric designators operating to assign each advertising space a unique alphanumeric combination; and, verifying that the host computer has not already received participant advertiser data from the participant advertiser computer identifying a pre-established quantity of advertising spaces within the advertising area.

In still another embodiment, the invention comprises a system for facilitating the placement of advertising by participant advertisers within an advertising area having a plurality of advertising spaces defined by first locations along a first axis and second locations along a second axis. The system comprises a computer memory for receiving from a plurality of remote computers and storing sponsored good or service data identifying a sponsored good or service for association with the advertising area, first advertising space data and price data reflecting a price paid for a first advertising space, and second advertising data and second price data reflecting a price paid for a second advertising space. The system also comprises a processor for associating the sponsored good or service data with the advertising area, for transmitting to a remote computer the advertising area and a sponsored good or service identifier comprised within the sponsored good or service data and associated with the advertising area, for determining, based on an outcome of a future event, a resultant advertising space from among the plurality of advertising spaces, and for identifying the participant advertiser having selected and purchased the resultant advertising space for the purpose of distributing the sponsored good or service. According to this embodiment, the price paid for the first advertising space and the price paid for the second advertising space vary depending on the time the price data was received.

Thus, this invention provides a new and useful means for on-line advertising where multiple parties can advertise their goods and services, and receive additional incentives to do so in a manner that will increase advertisement viewership and participation. Additional incentives for participant advertisers or registered users may also include the receipt of a discounted coupon or stored value card, an opportunity to advertise or promote a product, business, message or cause to a targeted audience interested in the sponsored webpage content, to participate in social networking opportunities catalyzed by sponsored webpage activities, to be identified with political messages or charitable organizations involved in the sponsored webpage, to invest in a revenue opportunity which may derive from overall traffic and advertising activity associated with the sponsored webpage, to monitor sporting events, statistics and scores, to monitor elections or news or other events of interest, to receive valuable coupons or credits toward the purchase of consumer goods or services, and to potentially receive the sponsored good or service at a significant cost savings.

While certain embodiment are referenced above, other embodiments, systems, methods, features, and advantages of the present invention will be, or will become, apparent to one having ordinary skill in the art upon examination of the following drawings and detailed description. Additionally, where terms such as “advertising space” are discussed in association with certain embodiments, the associated disclosure and functionality will be understood to equally apply to like terms, such as “discount space”, that are discussed in association with other embodiments. It is intended that all such additional systems, methods, features, and advantages included within this description, be within the scope of the present invention, and be protected by the accompanying claims.

### BRIEF DESCRIPTION OF THE DRAWINGS

The present invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a graphical representation of a multiple party advertisement facilitation system.

FIG. 2 is a block diagram of the interfaces in the multiple party advertisement facilitation system of FIG. 1.

FIG. 3 is a block diagram of one form of a computer or server of FIG. 1 and/or FIG. 2, having a memory element with a computer readable medium for implementing the multiple party advertisement facilitation system.

FIG. 4 is a flowchart showing steps in the setup portion of the multiple party advertisement facilitation system according to an exemplary embodiment.

FIG. 5 is a flowchart showing steps in the participant advertiser solicitation portion of the multiple party advertisement facilitation system according to an exemplary embodiment.

FIG. 6 is a flowchart showing steps in the secondary advertiser solicitation portion of the multiple party advertisement facilitation system according to an exemplary embodiment.

FIG. 7 is a flowchart showing steps in an execution portion of the multiple party advertisement facilitation system according to an exemplary embodiment.

FIG. 8 is a flowchart showing steps in a completion portion of the multiple party advertisement facilitation system according to an exemplary embodiment.

FIG. 9 is a first example of an empty advertising area according to the embodiment of FIG. 4.

FIG. 10 is a second example of an empty advertising area according to the embodiment of FIG. 4.

FIG. 11 is a first example of a partially filled advertising area in accordance with a particular embodiment of the present invention.

FIG. 12 is a second example of a partially filled advertising area in accordance with a particular embodiment of the present invention.

FIG. 13 is an example of a filled advertising area in accordance with a particular embodiment of the present invention.

FIG. 14 is an example of a pre-filled advertising area in accordance with another embodiment of the present invention.

FIG. 15 is a flowchart showing steps in assigning advertising spaces according to a code-based promotion in accordance with another embodiment of the present invention.

FIG. 16 is a flowchart showing steps in the reassignment of advertising spaces through an auction process in accordance with another embodiment of the present invention.

FIG. 17 is an example of a filled advertising area, according to a certain embodiment, where there is a high potential for the resell of an advertising space.

FIG. 18 is a flowchart showing steps through which a consumer might establish an advertising area based on a selected consumer good or service using the invention according to another embodiment of the present invention.

FIG. 19 is an example landing page from which visitors can locate and purchase advertising spaces, according to a certain embodiment.

FIG. 20 is an example search results page listing sponsored goods presently being offered in association with advertising areas, according to a certain embodiment.

FIG. 21 is an example of an advertising area in a particular embodiment used to demonstrate certain features of the present invention.

FIG. 22 is an example of an advertising area in a particular embodiment used to demonstrate additional features of the present invention.

FIG. 23 is an exemplary screen shot of a checkout step of purchasing a discount space according to certain embodiments.

FIG. 24 is an exemplary screen shot of a payment step of purchasing a discount space according to certain embodiments.

FIG. 25 is an exemplary screen shot of a confirmation step of purchasing a discount space according to certain embodiments.

### DETAILED DESCRIPTION

The description that follows describes, illustrates and exemplifies one or more particular embodiments of the present invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the present specification is intended to be taken as a whole and interpreted in accordance with the principles of the present invention as taught herein and understood to one of ordinary skill in the art.

In some embodiments, the present invention provides a system through which multiple parties can advertise or promote any type of goods, services, or even ideas, in an environment that provides multiple dynamic incentives for viewership, participation and growth of enrollment of users of the hosted system. Though not all parties are required in all embodiments, the exemplary embodiment primarily discussed below brings together into a common computerized environment system users in the form of sponsors, participant advertisers, secondary advertisers and visitors where advertising is displayed and a sporting event or some other future event or subject of interest to users may be monitored and assessed. Sponsors may be any party wishing to sponsor a particular webpage associated with a sporting event or subject of interest, and they are typically responsible for choosing the sponsored good or service to be associated with the sponsored webpage. In a typical embodiment, the sponsor is a company that offers or sells goods or services at retail, and the sponsored good or service is a good or service offered or sold by the sponsor through the course of its regular operations. In other embodiments, the sponsor may be a charity organization that receives donations when discount spaces are purchased.

Sponsors may, in addition to selecting a sponsored good or service to initiate the sponsored webpage and be sold through the sponsored webpage to a participant advertiser, choose to offer identical items or similar items to webpage visitors through a “buy it now” offer. Participant advertisers may then choose to purchase an advertising space on the sponsored webpage, purchase the item directly via the buy it now offer, or both. In some embodiments, the sponsor may alternatively offer coupons or stored value cards in exchange for the participant advertiser's purchase of an advertising space. In fact, it may be the coupon or stored value card that is actually being purchased, and the advertising space is simply awarded as an additional incentive. These coupons may, for example, be associated with the sponsor's goods or services offered through traditional retail channels. The coupons may be valued so as to partially or fully offset the purchase price of the associated advertising space, or even be valued higher than the purchase price as discussed in association with other embodiments below. Visitors to the webpage may select offers on the sponsored webpage or may choose to enroll as a member in order to be a participating advertiser, or both.

The sponsor itself is an advertiser in the exemplary embodiments inasmuch as the sponsor is advertising its name, brand, and/or goods or services through the promotion of the sponsored good or service. However, the present system and method may also allow others to advertise. As will be discussed, participant advertisers may purchase advertisement space from the sponsor or host, and secondary advertisers may also post advertisements. These many parties need not be co-located, but rather can be located anywhere with access to a computer network, provided they have hardware and respective software allowing them to interact with the advertisement system.

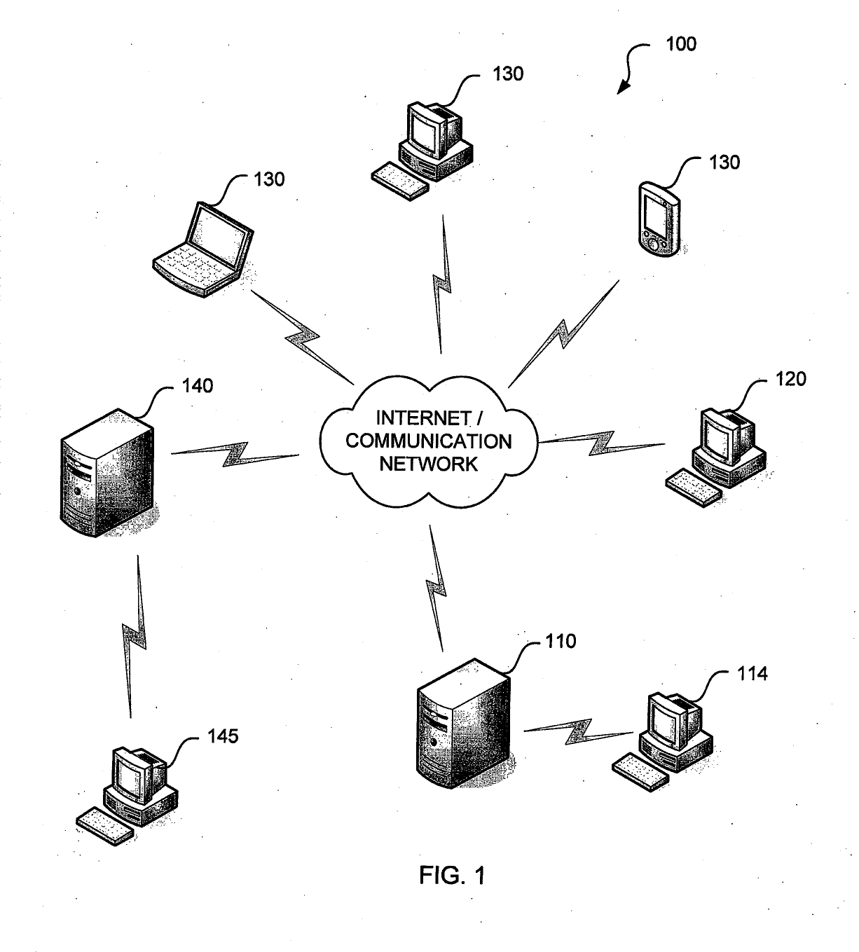

FIG. 1 is a graphical representation of a computer-based or implemented multiple party advertisement facilitation system 100. The system includes a plurality of participant advertiser remote computers 130, which can be any variety of hardware devices, such as those shown, that are capable of connection to and communication with a network, such as the Internet or other computer network, in a manner which is known in the art and which will be further understood from the below description. These remote computers 130 each can run an interface program, such as an Internet browser application for connecting to the Internet/network, that is capable of communicating with the multiple party advertising facilitation system 100, which can be server-based. Specifically, for communicating with participant advertiser remote computers 130, an advertisement system server 110 is connected to and in communication with a network, such as the Internet, in a manner which is known in the art. Firewall and other security systems and applications (not shown) may be used to prevent and deter unauthorized access to advertisement system server 110, as is known in the computer networking art.

In a similar manner, sponsor remote computer 120 and secondary advertiser server 140 are separately connected to and in communication with the network, such as the Internet. Though shown as directly connected, sponsor remote computer 120 may be connected to the network through a sponsor network. Sponsor remote computer 120 is equipped with sponsor computer application interface 220 allowing it to interact with the multiple party advertisement system application 210 through the network. Secondary advertiser server 140 may be a computer device specific to a single secondary advertiser, or may serve as a collection point for secondary advertisements from a number of secondary advertisers, as will be explained below. Server 140 is equipped with secondary advertiser application interface 240 for communicating with the multiple party advertisement system application 210 through the network. Though one server 140 is shown, there may be many, such as a server pool.

For the advertisement system server 110 and multiple party advertisement system application 210 therein, as will be described in more detail below, an advertisement system administrator computer 114 is connected to and placed in communication with the advertisement system server 110 for interfacing with the advertisement system server 110 to provide installation, set-up, and/or ongoing maintenance interface functions. Likewise, for the secondary advertiser server 140, a secondary advertiser computer 145 is connected thereto for interfacing and providing input to secondary advertiser server 140.

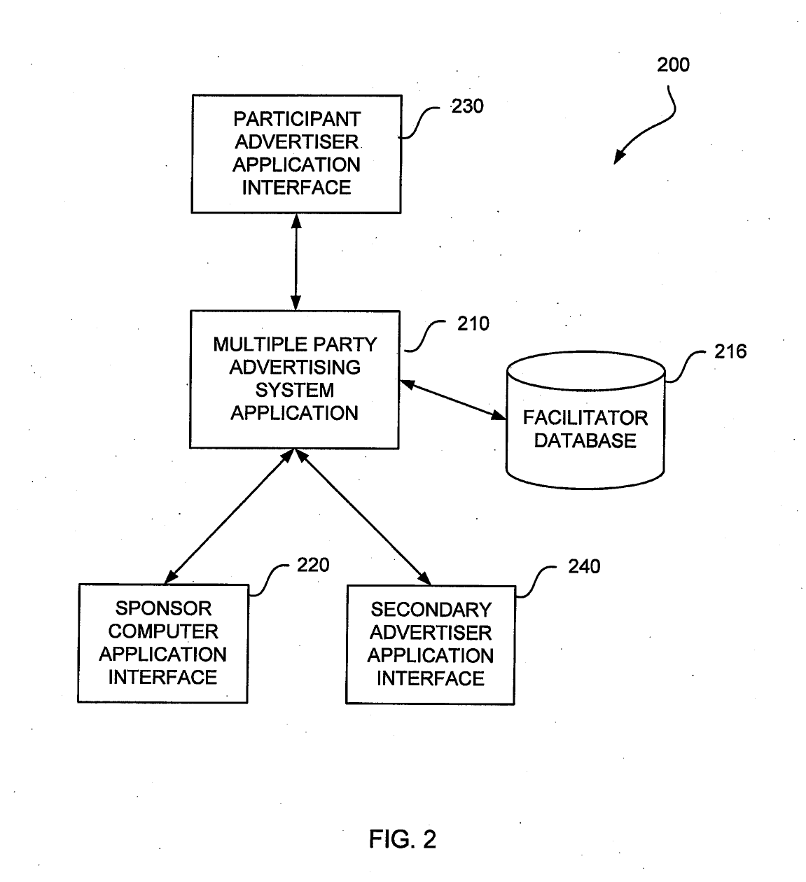

FIG. 2 is a block diagram of a computer-based or implemented system 200 for facilitating multiple party advertisement system transactions which can be implemented within the computer-based or implemented multiple party advertisement system 100 of FIG. 1. Specifically, each participant advertiser remote computer 130 of FIG. 1 can enable participant advertisers to interface with a multiple party advertisement system application 210 through a participant advertiser application interface 230. Similarly, sponsor remote computer 120 of FIG. 1 can enable the sponsor to interface with the multiple party advertisement system application 210 through sponsor computer application interface 220, and secondary advertiser server 140 of FIG. 1 can enable the secondary advertiser to interface with the multiple party advertisement system application 210 through secondary advertiser application interface 240. Further, the multiple party advertisement system application 210 of FIG. 2 can also represent and generate various sets of interface screens and provide functionality for performing all of the functions provided by the multiple party advertisement system 100, and is further connected to and in communication with an advertising/sponsor facilitator database 216 residing within a memory.

Certain embodiments may provide different application interfaces 230 depending on the type of user device 130 that is being used. For example, in certain embodiments, the content provided through system 200 may be tailored for display on handheld devices with smaller screen sizes. Certain components of the system application 210 may even be downloaded to the mobile device 130 to facilitate its participation with the system. In this manner, participant advertisers or other users may access and interact with the system 100 while on the move, and as advertising areas or discount boards are being filled up. Such full time access would also help enable users to monitor the resale of spaces or coupons, as will be discussed below.

In still other embodiments, the system application 210 may operate through a social media network, such as FACEBOOK. In this manner, participants and sponsors could interact with the same functionality as the system 100 otherwise offers, but through a well-known medium that provides quick and easy access to friends and contacts. In this manner, one user may be able to quickly invite other users to purchase advertising spaces in hopes of filling up the advertising area and meeting a reserve. Here, the advertisement system server 110 would still manage the advertising area, but participant advertisers would interact through the medium of the social network.

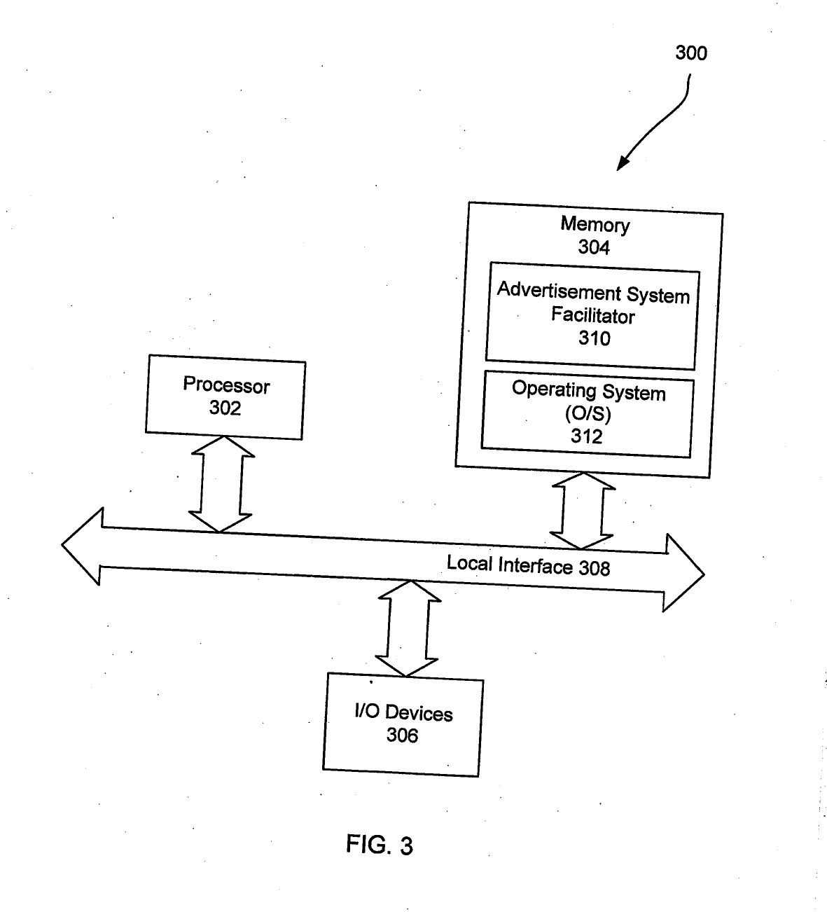

FIG. 3 is a block diagram of a computer 300 housing one or more software applications which are a part of and facilitate the multiple party advertisement system 100. Computer 300 may be any one of the advertisement system server 110, advertisement system administrator computer 114, sponsor remote computer 120, participant advertiser remote computer 130, secondary advertiser server 140, and/or or secondary advertiser computer 145 from FIG. 1. However, in the preferred embodiment, no individual software application is needed for sponsor remote computer 120, participant advertiser remote computer 130 or secondary advertiser server 140 to interact with system 100. Accordingly, for these devices, advertisement system facilitator 310 would simply take the form of a client computer-based device utilizing an Internet browsing interface application. Computer 300 may include a memory element 304. Memory element 304 may include a computer readable medium for implementing the multiple party advertising facilitation system 100, and for implementing particular advertisement system transactions.

The advertisement system facilitator 310 may be implemented in software, firmware, hardware, or any combination thereof. For example, in one mode, the advertisement system facilitator 310 is implemented in software, as an executable program, and is executed by one or more special or general purpose digital computer(s), such as a personal computer (PC; IBM-compatible, Apple-compatible, or otherwise), personal digital assistant, workstation, minicomputer, mainframe computer, computer network, “virtual network” or “internet cloud computing facility”. Therefore, computer 300 may be representative of any computer in which the advertisement system facilitator 310 resides or partially resides, such as the advertisement system server 110 of FIG. 1.

Generally, in terms of hardware architecture, as shown in FIG. 3, computer 300 includes a processor 302, memory 304, and one or more input and/or output (I/O) devices 306 (or peripherals) that are communicatively coupled via a local interface 308. Local interface 308 may be, for example, but is not limited to, one or more buses or other wired or wireless connections, as is known in the art. Local interface 308 may have additional elements, which are omitted for simplicity, such as controllers, buffers (caches), drivers, repeaters, and receivers, to enable communications. Further, local interface 308 may include address, control, and/or data connections to enable appropriate communications among the other computer components.

Processor 302 is a hardware device for executing software, particularly software stored in memory 304. Processor 302 can be any custom made or commercially available processor, a central processing unit (CPU), an auxiliary processor among several processors associated with computer 300, a semiconductor based microprocessor (in the form of a microchip or chip set), another type of microprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. Processor 302 may also represent a distributed processing architecture such as, but not limited to, SQL, Smalltalk, APL, KLisp, Snobol, Developer 200, MUMPS/Magic.

Memory 304 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 304 may incorporate electronic, magnetic, optical, and/or other types of storage media. Memory 304 can have a distributed architecture where various components are situated remote from one another, but are still accessed by processor 302.

The software in memory 304 may include one or more separate programs. The separate programs comprise ordered listings of executable instructions for implementing logical functions. In the example of FIG. 3, the software in memory 304 includes the advertisement system facilitator 310 in accordance with the present invention, and a suitable operating system (O/S) 312. A non-exhaustive list of examples of suitable commercially available operating systems 312 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). Operating system 312 essentially controls the execution of other computer programs, such as the advertisement system facilitator 310, and provides scheduling, input-output control, file and data management, memory management, and communication control and related services.

The advertisement system facilitator 310 may be a source program, executable program (object code), script, or any other entity comprising a set of instructions to be performed. When a “source” program, the program needs to be translated via a compiler, assembler, interpreter, or the like, which may or may not be included within memory 304, so as to operate properly in connection with operating system 312. Furthermore, the advertisement system facilitator 310 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, .Net, HTML, and Ada. In one embodiment, the advertisement system facilitator 310 is written in Java.

I/O devices 306 may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, I/O devices 306 may also include output devices, for example but not limited to, output modules for PLCs, a printer, bar code printers, displays, etc. Finally, I/O devices 306 may further comprise devices that communicate with both inputs and outputs, including, but not limited to, a modulator/demodulator (modem; for accessing another device, system, or network), a radio frequency (RF) or other transceiver, a telephonic interface, a bridge, and a router.

If computer 300 is a PC, workstation, PDA, or the like, the software in memory 304 may further include a basic input output system (BIOS) (not shown in FIG. 3). The BIOS is a set of essential software routines that initialize and test hardware at startup, start O/S 312, and support the transfer of data among the hardware devices. The BIOS is stored in ROM so that the BIOS can be executed when computer 300 is activated.

When computer 300 is in operation, processor 302 is configured to execute software stored within memory 304, to communicate data to and from memory 304, and to generally control operations of computer 300 pursuant to the software. The advertisement system facilitator 310, and O/S 312, in whole or in part, but typically the latter, may be read by processor 302, buffered within processor 302, and then executed.

When the advertisement system facilitator 310 is implemented in software, as is shown in FIG. 3, it should be noted that the advertisement system facilitator 310 can be stored on any computer readable medium for use by or in connection with any computer related system or method, although in certain embodiment, the advertisement system facilitator 310 is implemented in a centralized application service provider (ASP) arrangement. In the context of this document, a computer readable medium is an electronic, magnetic, optical, or other physical device or means that can contain or store a computer program for use by or in connection with a computer related system or method. The advertisement system facilitator 310 can be embodied in any type of computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” may be any means that can store, communicate, propagate, or transport the program for use by or in connection with the instruction execution system, apparatus, or device. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In another embodiment, where the advertisement system facilitator 310 is implemented in hardware, the advertisement system facilitator 310 may also be implemented with any of the following technologies, or a combination thereof, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

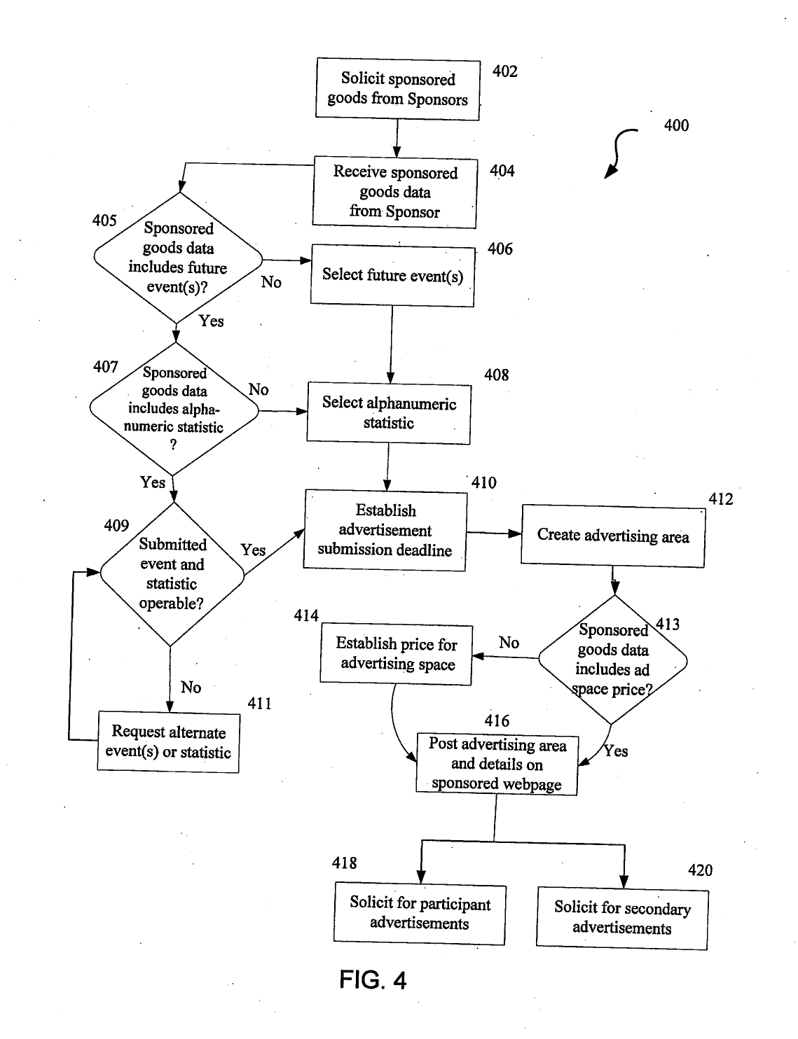

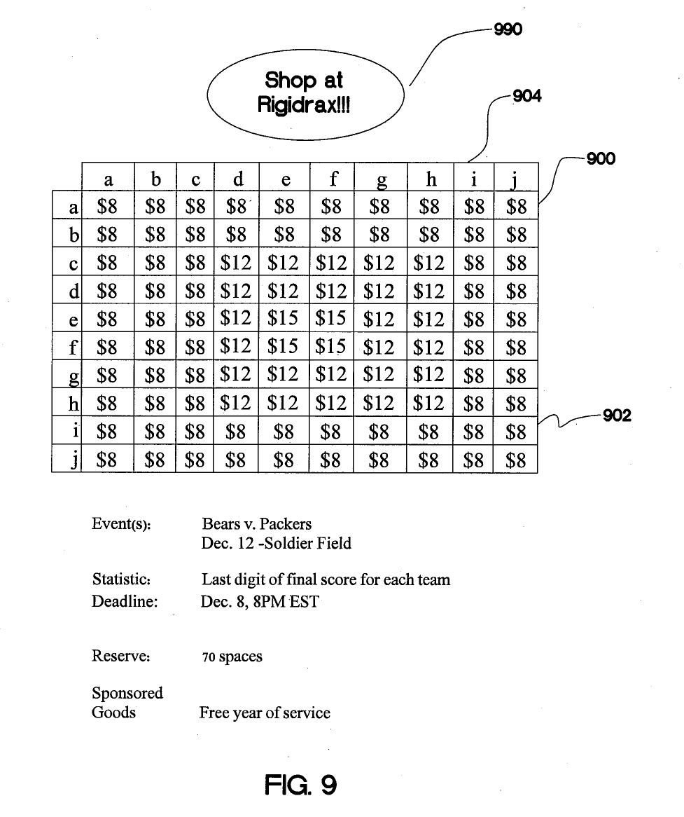

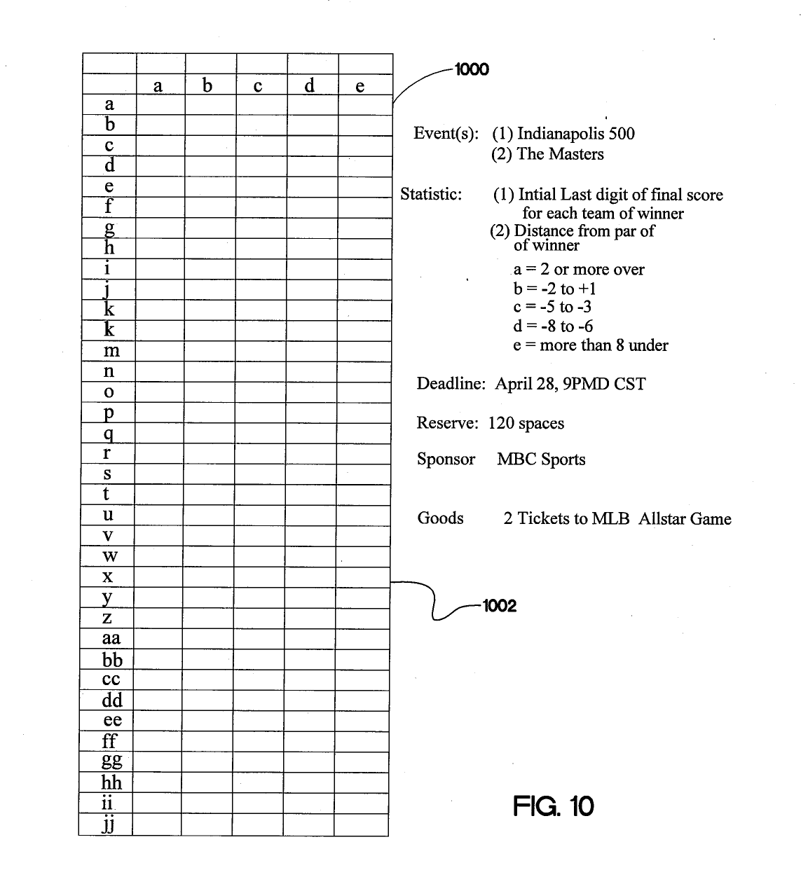

The multiple party advertisement system 100 allows for the creation of discount boards or advertising areas, such as advertising areas 900 and 1000 shown in FIGS. 9 and 10. Each advertising area establishes a separate environment in which operation of the advertisement system 100 takes place. In one embodiment, each advertising area is displayed and updated on a unique webpage within a website executed on and managed by the advertisement system server 110. The data associated with each webpage corresponding to an advertising area is housed within the facilitator database 216, which is accessed and updated through the multiple party advertisement system application 210 housed on server 110. Each advertising area may be viewed through the use of computer 300 with access to the Internet. Each advertising area is also defined, at least in part, by data received from the various parties, such as sponsored good or service data from a sponsor, advertising space data from a participant advertiser or other user, secondary advertising data from secondary advertisers, and/or other data. This will be clearer with reference to FIGS. 4-8, which illustrate the steps of developing, filling, showcasing an advertising area, and ultimately determining a sponsored good or service associated therewith, according to an exemplary embodiment of the present system and method. As FIGS. 4-8 are referenced, other figures will be referenced to explain at least the various elements and functions of an advertising area.

As will be described in greater detail herein, each sponsored webpage and advertising area or discount board is associated with one or more future events. These events may be any event yet to occur that, when it does occur, will produce some definite alphanumeric result. For instance, a future event may be an upcoming sporting event, such as a basketball game. When completed, the basketball game will have produced a variety of certain alphanumeric results, such as, for instance, the final score. Other future events conceived by the present invention that might be associated with a particular sponsored webpage or advertising area include financial information, weather-related data, political election results or any other event yet to occur which will yield a discreet alphanumeric result. There are many other types of future events that may also suffice, with few limitations other than those set forth above. Typically, a future event is more desirable when it will produce its discreet alphanumeric result not sooner than two weeks and in less than six months, though future events not meeting this timeframe could be used as well.

For each future event that an advertising area or discount board is associated with, an alphanumeric statistic will be selected for further association with the advertising area. Using the example above, the alphanumeric statistic associated with the basketball game would be the final score. The result of this alphanumeric statistic will not be known until the future event is complete. The combination of the one or more associated future events, and their corresponding alphanumeric statistics, can serve to define the shape and size of the advertising area or discount board. This is because, for each possible result, there exists one advertising space or discount space, all of which combine to form the advertising area or discount board. As the possible outcomes increase, either the advertising area grows, the advertising spaces comprising the advertising area shrink, or a combination of the two. As will be further understood, there are advantages to a greater number of advertising spaces, such as increased advertising revenue or decreased advertising space price, and disadvantages, such as potentially diminished quality or viewership of advertising spaces. These factors should be taken into account when selecting future events and associated alphanumeric statistics.

As an example, FIG. 9 shows a first advertising area 900 which has been associated with a football game between the CHICAGO BEARS and the GREEN BAY PACKERS, to be played on December 12 at Soldier Field. This football game is future event 910, and alphanumeric statistic 912 to be used is the final score, or more particularly the last digit of each team's final score. Thus, each team will produce a single digit, leaving a possibility of one hundred alphanumeric results. Accordingly, advertising area 900 shows one hundred individual advertising spaces 902, and is represented as a 10×10 square or matrix. Each team is assigned an axis 904, which is assigned one possible alphanumeric result for that team. However, as shown, the axis locations are labeled with letters and not numbers. This is done so as to introduce an element of randomness in the selection of advertising spaces. If the axes locations were labeled with the numerals 0-9 in advance, certain advertising spaces would be more likely to be the resultant advertising space than others. In some embodiments, this may be desirable, as it would cause those advertising spaces to potentially command a higher price. However, by initially masking the numeric designations, all advertising spaces would have an equal likelihood of being the resultant advertising space, and advertising space price would merely be a function of location from an advertisement placement standpoint. Thus, advertising spaces 902 of FIG. 9 that are in the center are slightly higher priced than those along the outside. As explained below, once the advertising area is full or at a pre-designated time after which no advertising spaces are sold, the axes locations will be revealed. Alternatively, advertising spaces could still be for sale after this time, but at a price reflecting their likelihood of being the resultant advertising space.

FIG. 10 shows an example of a second advertising area 1000, which is associated with two separate future events 1010—the INDIANAPOLIS FIVE HUNDRED (500) and the MASTERS golf tournament. In this case, alphanumeric statistics 1012 to be used are the initial pole position of the winner of the INDIANAPOLIS 500 (which can be a number from 1 to 33 in this case), and the distance from par of the winning score of the MASTERS. In this case, a ranged scale has been established to group possible alphanumeric outcomes of the MASTERS statistic. This can be done so as to limit the possible alphanumeric results, and in turn, the size of the advertising area. With these associations, advertising area 1000 is comprised of 165 advertising spaces 1002, and is 33×5 advertising spaces in size. Note that, in this case, only one axis has its locations masked. Based on the future events, the elected alphanumeric statistics and historical data, the advertising space in columns c and d will likely command a higher price in this example.

Each advertising area also has associated with it a sponsored good or service. The sponsored good or service may be anything of value, but is typically a consumer retail good or service. Alternatively, the sponsored good or service could be a stored value card, credit, or coupon towards the purchase of goods or services from the sponsor. In such a case, the stored value card, credit or coupon would be of a value greater than the purchase price of an advertising space. In this manner, the sponsored good or service is not a specific item or service. Instead, the ultimately good or service selected is left up to the recipient of the stored value card, credit or coupon making the advertising area appeal to a larger audience.

In an exemplary embodiment, the sponsored good or service is put forth by the sponsor, and the participant advertiser that purchased the advertising space corresponding to the alphanumeric result is entitled to receive the sponsored good or service. This is referred to as the resultant advertising space. In the case of advertising area 900, the sponsored good or service is a free year of service from the sponsor, ACME Cellphones, Inc. In the case of advertising area 1000, the sponsored good or service is two tickets to the Baseball All-Star Game offered by MBC Sports.

FIG. 4 provides a flowchart depicting the process steps involved with developing an advertising area according to an exemplary embodiment of the present invention. In this embodiment, the process is initiated by the host, and in particular by the advertisement system application 210 and/or facilitator 310, soliciting or requesting sponsored good or service data from potential sponsors of an advertising area, at step 402, such as by transmitting such a request to a client device requesting such data. In embodiments where the sponsor serves as the host and operates the multiple party advertisement system applications 210 directly, no solicitation or request is required. In other embodiments, the host may simply acquire a sponsored good or service to be associated with the advertising area such that no sponsor is needed. Solicitation step 402 may involve solicitation in association with a pre-determined future event and alphanumeric statistic. In other words, in some embodiments, the host may already have defined the advertising area, and is only looking to connect it with a sponsored good or service. In this case, many of the steps in FIG. 4 become unnecessary. In the exemplary embodiment depicted, the host has not defined the advertising area, and is merely seeking sponsorship.

The host and advertising application 210 and/or facilitator 310 receives sponsored good or service data from a sponsor, at step 404, such as by transmitting a request for sponsored good or service data to a client device, and receiving one or more transmitted responses from the client device providing the sponsored good or service data. At a minimum, this sponsored good or service data will set forth a sponsored good or service, and generally will also set forth a retail price associated with that sponsored good or service. Various identifiers may be used to set forth a sponsored good or service, such as a model number, a serial number, a brand or product name, bar code data, a visual or textual description, or any other data that is unique to the sponsored good or services such that it can be identified by advertisement system application 210. Where no retail price is provided, the host may request this information (not shown). The sponsored good or service data may also include other details such as instructions on what future event and alphanumeric result the advertising space is to be associated with. There are many reasons why a sponsor may want to specify this information. It may want to select events that are somehow associated with itself. For example, perhaps MBC Sports, the sponsor in FIG. 10, is broadcasting the INDIANAPOLIS 500 and the MASTERS golf tournament. By connecting the advertising area to these future events that it is involved with, it will bring attention to them, and thus provides an additional source of advertising through advertisement system 100. Another reason is that each future event is tied to a particular future date, and thus selecting the events allows the sponsor to dictate how long the advertising area will be available. The longer an advertisement is to run, the higher price the advertising space will command.

Once the sponsored good or service data is received, the advertisement system application 210 determines whether it includes any future events at step 405. If not, the advertisement system application 210 selects or determines one or more future events at step 406, and alphanumeric statistics at step 408, to be associated with the sponsored good or service. If the sponsored good or service data includes a future event, the advertisement system application 210 performs a check to determine if alphanumeric statistics designation(s) have been received at step 407. If none are present, the advertisement system application 210 requests one or more statistics designation(s) associated with the designated future event(s) at step 408. While generally any future event that will produce a definite result can be used, it may be that sponsors submit alphanumeric statistics that are not compatible with the advertisement system application 210. For instance, in the example of FIG. 9, if the sponsor simply submitted “the final score” as a statistic designation without further instruction as to how to use that statistic, the instruction would be ambiguous. Thus, the advertisement system application 210 performs one or more checks to determine if the sponsored good or service data includes sufficient instructions at step 409, and transmits one or more requests for alternative and/or additional instructions at step 411, if necessary.

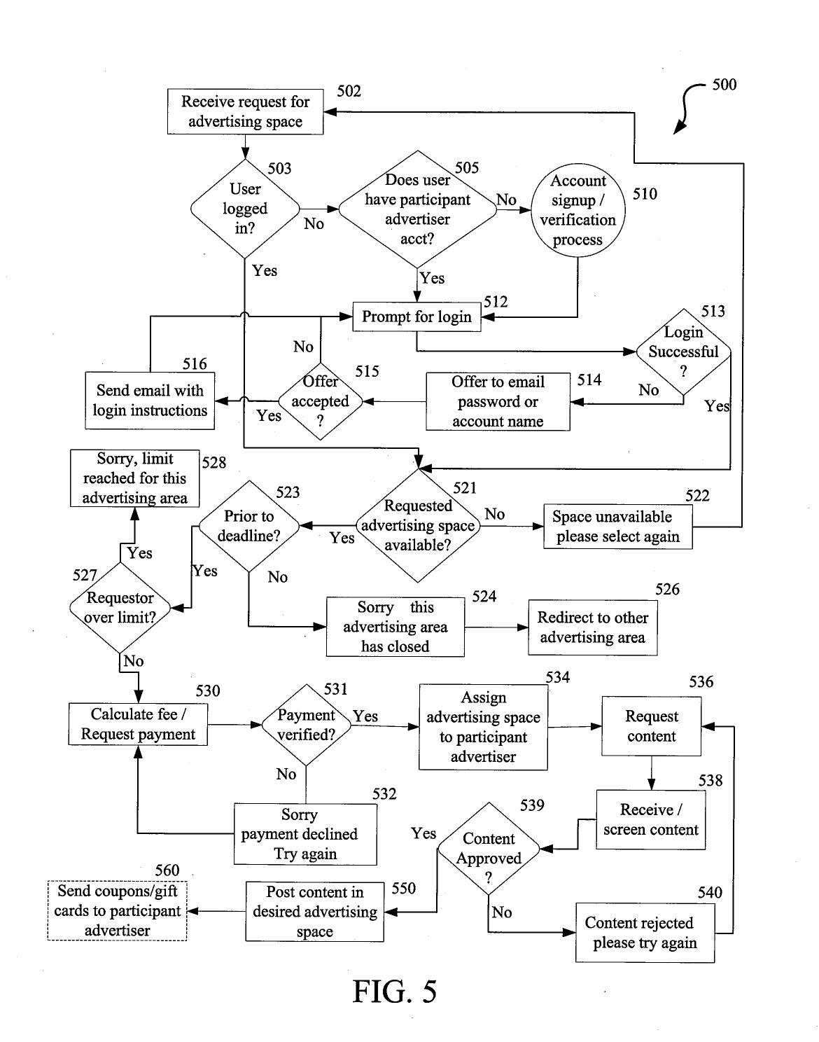

Once a suitable alphanumeric statistic designation is selected and received by the advertisement system application 210, the application 210 proceeds to establish an advertisement submission deadline at step 410. As will be seen with respect to FIG. 5, advertisement system application 210 receives advertisement submissions from participant advertisers for advertising spaces within the advertising area. Because the advertising area is associated with a future event, a deadline for submissions must be established. Typically, and as is the case with advertising areas 900 and 1000, this deadline is a certain amount of time prior to the start of the associated future event. As the future event draws closer, more information is known about it, and predictions as to the controlling alphanumeric result will likely become more accurate. One means to eliminate this phenomenon is to mask the axes locations, such as in the case of axes 904 of FIG. 9, and only reveal them at the submission deadline. Where this is not done and submissions are allowed after the axes locations are revealed, the closer the submission deadline is to the completion of the final event, the more easy it will be to predict the resultant advertising space. In this case, the advertising spaces most likely to be the resultant advertising space will increase greatly in value as the deadline nears, but the other advertising spaces will lose value. In any event, the preferred embodiment establishes submission deadline, at step 410, prior to taking submissions for advertising spaces.

In the exemplary embodiment of FIG. 4, once the deadline is established, the advertising area is created by the advertisement system application 210 at step 412. However, prior to posting or transmitting the advertising area to the interface screen of a client device at step 416, the advertisement system application 210 checks or determines whether the sponsored good or service data includes a sales price for the advertising spaces at step 413, and, if not, establishes a sales price at step 414. In embodiments where the retail price of the sponsored good or service is known but no sales price is transmitted or provided to the advertisement system application 210, one method of determining a sales price for the advertising spaces is simply to divide the retail price of the sponsored good or service by the number of advertising spaces. However, there are numerous ways to set the advertising space price so as to generate revenue and potential profits for the sponsor, the host, or both.

In some embodiments, such as those depicted in FIGS. 9 and 10, the advertisement system application 210 will determine and/or receive from a client device a reserve, which is a pre-determined number of advertising spaces that must be purchased by participant advertisers in order for the sponsored good or service to be sold through the alpha-numeric selection process. If this reserve is not met prior to the established deadline, the advertising area will be canceled, or at least postponed, and a selected advertising area will not be selected (at least temporarily). However, where the reserve is met, the process will continue and the advertisement system application 210 will determine the resultant advertising space and distribute the sponsored good or service, even if not all of the advertising spaces have been purchased. In such cases, it is preferable for the advertisement system application 210 to determine and/or received from a client device an advertising space price based on the reserve rather than the total number of advertising spaces. If the advertising space price is the retail price of the sponsored good or service divided by the reserve, any advertising spaces sold beyond the reserve will be pure profit.

Generally, it is in the best interest of everyone involved if the reserve is met. Accordingly, the advertising system application 210 may provide incentives for additional participation on the advertising area by offering awards or “finder's fees” to participant advertisers that have already purchased into the area if they are able to direct others to the area that make a purchase. This could be done by broadcasting a hyperlink to the website address housing the advertising area via email or social media.

In some embodiments, the advertising space price is variable, and is reduced as the future event draws closer. As will be seen, the earlier the advertising space is purchased prior to the future event, the longer the participant advertiser will have its advertisement posted on the advertising space. Thus, a higher price is warranted. Other embodiments may include volume discounts for purchases of multiple advertising spaces, or reduced rates for preferred participant advertisers, such as participant advertisers that purchase a predetermined number of spaces over a predetermined time frame. Ultimately, the free market will control whether the host or sponsor selected an appropriate price for the advertising spaces.

In some embodiments, coupons or stored value cards may be used as additional incentive for participants to purchase advertising spaces. These coupons would be provided to the participant advertiser upon purchase of one or more advertising spaces, providing further value in addition to that obtained through the right to advertise, revenue from secondary advertising, and an opportunity to receive the sponsored good or service. The coupons may be distributed by the sponsor and related to the sponsor's goods or services, or may be related to other goods or services, and brokered independently by the system host. In the first instance, returning to the example of FIG. 9 where the sponsor is ACME Cell Phones and the sponsored service is a free year of cell coverage, participant advertisers might receive 30-minute domestic phone cards in exchange for each advertising space purchased. In the second instance, the host may be offering coupons for a free hamburger at a fast food chain—i.e., something of value, but completely unrelated to the advertising area or sponsor.

Alternatively, the sponsored good or service itself could be a coupon or stored value card of a larger scale than those offered in association with the purchase of one or more advertising spaces. For instance, an advertising area comprised of 100 squares might be associated with a $1000 store credit good at any of the sponsor's retail outlets. However, with each purchase of an individual advertising space, a participant advertiser might receive a $10 coupon or stored value card at the sponsor's retail outlets. In the preferred embodiment, these lesser coupons would not be available for combination. In this manner, each coupon or stored value card will drive an individual sale from the sponsor, wherein any amount over the $10 limit will be paid from the participant advertiser to the sponsor.

Distribution or awarding of coupons or stored value cards in this manner could also be done strategically as a means to help sell advertising spaces in an advertising area that is not selling well. In this manner, it takes some of the risk out of setting the price for the advertising spaces too high. Instead of reducing the advertising space price after opening the advertising area to encourage sales, potential participant advertisers could be induced by establishing, or adjusting the value of, a coupon or stored value card reward in return for an advertising space purchase. Alternatively, such coupons could be used to induce bulk purchases. For instance, the purchase of a single advertising space may not come with any coupons or stored value cards. However, the coupons or stored value cards are distributed for purchases of 2 or more advertising spaces within an advertising area, and the value of those coupons/cards may increase as more advertising spaces are purchased.

In other embodiments, the actual purchase may be of the coupon or stored value card (at a discounted rate from the value the coupon or card represents). In exchange for the purchase, the user/participant advertiser is awarded the ability to select a discount space from the associated discount board. The system will identify that space with the user and, optionally, will display digital content selected or supplied by the user on the space selected or assigned. The digital content, which may be called “GameFace” in some embodiments, is then displayed for other visitors and identifies the owner of the space. The GameFace content may be an advertisement such as a logo or website associated with the user, or may be some other graphic or text.

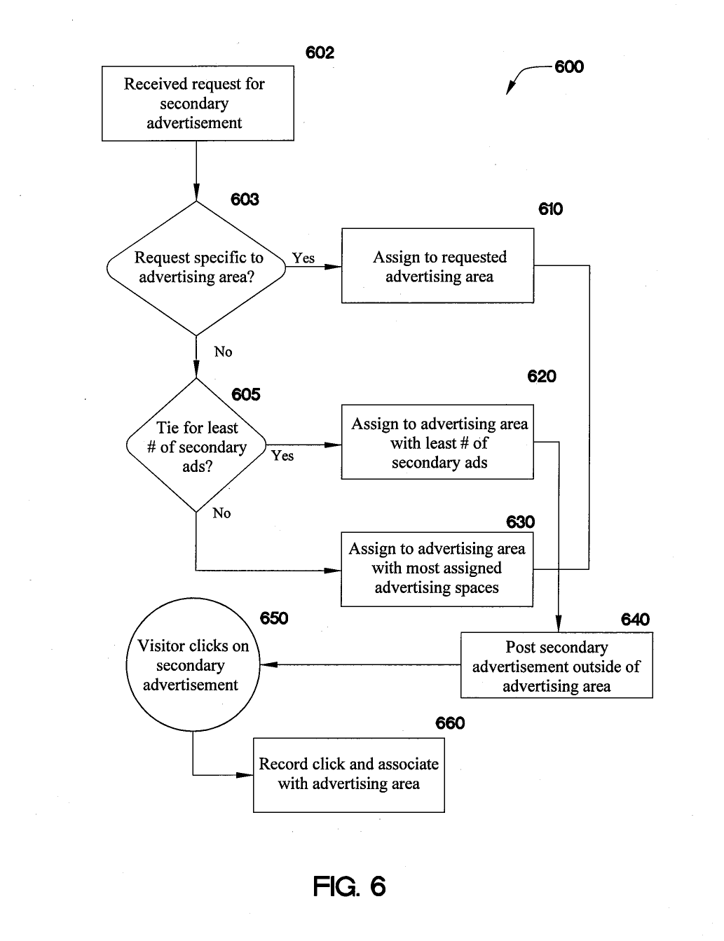

With all the necessary information related to the advertising area determined and/or received by the advertisement system application 210, the advertisement system application 210 is now ready to transmit the advertising area and associated details in the form of a webpage to a client device interface screen, at step 416. The advertisement system application 210 is then ready to receive participant advertisements, at step 418 (see FIG. 5), as well as secondary advertisements, at step 420 (see FIG. 6). In some embodiments, secondary advertisements, such as click-thru advertisement 990 of FIG. 9, are simply selected from an existing pool of such advertisements associated with the multiple party advertising facilitation system 100. The secondary advertisements may also be automatically transmitted to and received by the advertisement system application 210 from a third-party advertising warehouse. In this case, advertisement system application 210 may cycle the secondary advertisements over time and not necessarily be associate such secondary advertisements with any particular advertising area. Thus, advertisement system application 210 soliciting and receiving secondary advertisers particular to a specific advertising area, at step 420, is not necessary.

The advertisement system application 210 can then move to step 418, which includes soliciting and receiving participant advertisements at step 418, which may include linking the advertising area with search criteria. The search criteria are associated with the aspects that give definition to the advertising area, i.e, the future event, the sponsored good or service, the size of the advertising area, the advertising space price, the reserve criteria, the timing of the deadline, etc. By linking the advertising area in such a manner, the advertisement system application 210, can direct a participant advertiser to the webpage or interface screen having the advertising area based on the participant advertiser's query on the home or other top level webpage of the website or set of interface screens for an advertising area fitting the entered search criteria. For instance, the participant advertiser may want an advertising area offering advertising spaces under $20 that are tied to an NFL football game that closes by December 15th. Alternatively, the participant advertiser may be interested in an advertising area that is connected to a sponsored good or service of a cell phone and/or cell phone service for period of time. The search mechanism operates in the traditional manner, where the participant advertiser would enter a string into a search field. The system application 210 may be equipped with the ability to auto complete search strings or recommend certain search terms. The results of a query related to either of these interests might then lead the participant advertiser to an associated advertising area 900.

In some embodiments, the system application 210 may use information about the participant advertiser/registered user that is stored in a profile on the advertisement system server 110 in order to pre-select or preview certain advertising areas/discount boards. This profile might include information such as age, sex, whether the person has children, or other demographic or personal information. Alternatively, system application 210 may make a selection or recommendation based purely on the user's prior participation with the system 100. If the user has shown an interest in certain sport teams, the system might direct the user to advertising areas associated with specific future events involving those teams. If the user has shown an interest in certain types of products, the system might direct the user to advertising areas featuring specific sponsored goods, etc.

FIG. 5 provides at least some of the steps carried out by the advertisement system application 210 and associated with assigning an advertising space in a particular advertising area to a participant advertiser, such as a participant advertiser that has responded to the solicitation of step 418. Using a participant advertiser remote computer or client device 130, the advertisement system application is configured to allow a participant advertiser to locate an advertising area of interest and provide or transmit an option through the participant advertiser application interface 230 to select a particular advertising space within that advertising area. The participant advertiser may use the axes locations for the advertising space as a means to identify the space to the advertisement system application 210. Even if the true axes locations have not been revealed, the axes will still have preliminary location designations, such as shown in FIG. 9, for use in specifying advertising spaces within the advertising area. In some embodiments, the participant advertiser may request a plurality of particular advertising spaces concurrently, by selecting such advertising spaces at the remote computer 130 and transmitting such selections to the advertisement system application 210. In other embodiments, the participant advertiser may not have a preference as to which advertising space(s) it receives, so long as the space(s) are within the selected advertising area. As a result, the advertisement system application 210 can be configured to receive a request, at step 502, to select space generally and advertisement system application 210 will assign a space to the participant advertiser. The advertisement system application 210 can also be configured to determine whether the participant advertiser is recognized by the system at step 503.

Though certain embodiments need not require a log in, one exemplary embodiment of the advertisement system application 210 includes a login process including the advertisement system application 210 determining the identity of the participant advertiser. If the participant advertiser is not logged in, the advertisement system application 210 queries whether the participant advertiser has an account at step 505. If not, the advertisement system application 210 can be configured to transmit to a participant advertiser account creation prompts to create an account at step 510. Though not shown, such processes are well known in the art, and involve the participant advertiser submitting basic information such as name, shipping information, contact information, account name and password. In some embodiments, a working email address is required. The account name must be unique to the participant advertiser, so application 210 will continue to request account names until a unique one is received. Passwords typically must meet a convention relating to length and character differentiation. Once acceptable data is entered to create the account, application 210 stores the information in the facilitator database 216 and can be configured to send an email to the new participant advertiser's email address as part of a verification process. This email contains a link through which the participant advertiser can access the system and log in to the newly created account. In the process of doing this, the new account information is verified.

Whether the participant advertiser already has an account or interacts with the application 210 to create an account, the application 210 will transmit login prompts to the remote computer 130 to log in at step 512, if they have not already done so. If the login attempt is successful, at step 513, the application 210 will proceed to address the participant advertiser's requests, such as to purchase an advertising space. If not, the application 210 can be configured to transmit an offer to email the participant advertiser's password or account name, at step 514, to the email address stored in the facilitator database 216 for the participant advertiser. If this offer is accepted, at step 515, the application 210 will generate and send the email at step 516. Either way, the application 210 can then return to the login step 512 until the login attempt is successful.

Once application 210 has confirmed that the participant advertiser is logged in, it checks whether the requested advertising space(s) are available 521. In the exemplary embodiment, the application 210 can be configured to allow the advertising spaces to be sold on a first come/first served basis. If the application 210 determines that the requested space is unavailable, or if any of the space(s) are unavailable in the case of a request for multiple spaces, the application 210 will generate a message indicating as such at step 522 and redirect the participant advertiser to select a different advertising space. In some embodiments, the application 210 can transmit to the remote computer 130 the identity of the advertising spaces that are not available in the case of a multiple space request. As noted above, a participant advertiser may simply generally request an advertising space(s), without identifying which advertising space(s) within the advertising area, and the application 210 can then select the particular space(s) to assign to the participant advertiser. In this case, the system check within the application 210 at step 521 is replaced by an assignment step where application 210 can randomly select from available advertising spaces within the advertising area. Only if there are an insufficient number of advertising spaces to meet the participant advertiser's request will application 210 transmit to the remote compute a refusal indication denying the request at step 522.

Because of the speed of the electronic environment in which the transaction described in FIG. 5 takes place, it could be that more than one participant advertiser is seeking the same advertising space at the same time. Thus, assuming the requested advertising space(s) are availability, step 521 may include the advertisement system application 210 putting a hold on the requested advertising space(s) until the transaction is complete, or for a predetermined amount of time. Thus, if another participant advertiser submits a request to advertisement system application 210 for the same advertising space a few seconds later, the application 210 will designate the advertising space as unavailable 522, and the application 210 transmit a notification to the participant advertiser to select another advertising space.

Though it may be combined with the availability check performed by the application 210 at step 521, FIG. 5 shows that a second check is then made by the application 210 to determine if the deadline has been reached at step 523 for the given advertising area. As indicated, one advantage of the application 210 performing a separate check is that the participant advertiser is not directed to simply select another advertising space within the advertising area, but rather is directed to a completely different advertising area 526 where the deadline has not expired. In certain embodiments, application 210 can redirect the participant advertiser to an advertising area with characteristics similar to that in which the deadline has closed.

Another system check that may be performed by advertisement system application 210 is whether the particular participant advertiser requesting the advertising space(s) is over a pre-set limit of advertising spaces for the given advertising area. Part of the benefit of sponsoring an advertising area is for the sponsor to be involved with a number of participant advertisers. In doing so, the sponsor may select a pricing scheme for the advertising spaces such that the sum of the prices for all of the advertising spaces is actually less than the value of the sponsored good or service. This may still result in a benefit to the sponsor by drawing interest in the sponsor's goods or services from a high number of participant advertisers. For instance, if the sponsor is awarding low value coupons or stored value cards with each purchase of an advertising space, the sponsor may encourage sales far exceeding the value of those cards from the multiple participant advertisers. However, in such a scenario, an opportunistic visitor may recognize an arbitrage opportunity wherein all advertising spaces could be purchased at once in exchange for a guarantee of receiving the sponsored good or services. This result would be contrary to the intent of the sponsor. In such scenarios, the sponsor may wish to prevent participant advertisers from acquiring more than a set number of advertising spaces within the advertising area. To prevent this, application 210 may perform a check at step 527, which results in a refusal to sell the advertising space at step 528 if the participant advertiser requesting the advertising spaces has reached the proscribed limit.

Assuming the deadline for the advertising area has not been reached, the requested advertising space(s) are available, and the participant advertiser has not reached the limit of spaces they can acquire within the advertising area, advertisement system application 210 calculates the fees due for the requested advertising space(s) and requests payment at step 530. As discussed above, this fee may be a function of where the advertising space is located within the advertising area, the value of the sponsored good or service associated with the advertising area, the time left until the future event, whether or not any coupons or stored value cards are to be distributed, or other factors. The application 210 can be configured for payment to be received from a participant advertiser from a remote computer 130, and the application can then verify the payment, through a variety of processes, such as on-line credit card transactions, direct draft from a bank account, debiting a PAYPAL account, and other processes. Application 210 verifies receipt of the payment at step 531 and then proceeds to assign the requested advertising space(s) to the participant advertiser at step 534. If payment cannot be verified, application 210 informs the participant advertiser at step 532, such as by sending electronic data through the network to the participant advertiser's remote computer 130, and requests payment again at step 530. In the exemplary embodiment, once payment is received, it is held by the system host in an escrow account associated with the advertising area until the reserve is met. If the reserve is not met, the sponsored webpage will expire and be discontinued, and participating advertisers will be credited amounts paid for advertising space, and the sponsored good or service will not be sold to a participating advertiser through the sponsored webpage. If the reserve is met, the amounts received from participating advertisers for advertising spaces will be forwarded to the sponsor as payment for the sponsored good or service, as may be agreed to by the sponsor and the system host.

A significant feature of multiple party advertisement system 100 and application 210 in certain embodiments is that participant advertisers can interface with the application 210 to advertise within an advertising area. This is done by submitting advertising content through a remote computer 130 to the advertisement system server 110 and application 210 for placement of a purchased advertising space(s) within an advertising area. This content may be in a variety of known digital formats such as .bmp, .jpg, .tif, .mpg, .avi, .mov, and many, many more. Alternatively, a participant advertiser may simply submit text through participant advertiser application interface 230 which the advertisement system application 210 will convert to a format for placement on the advertising space. Pictorial and/or textual content may be displayed within the advertising space. If multiple advertising spaces are purchased, each may be given the same content or may provide unique content. Thus, a participant advertiser could create a pattern with several advertising spaces that combines to create a larger impression. The size of the advertising space may be a limiting factor as to the amount of content that can be displayed, thus participant advertisers must be practical as to the pixel size of the content they submit. However, system 100 is equipped to limit concerns over this problem.

First, an advertising area may be created such that the advertising spaces are of a fixed pixel size that is determined to be sufficient for most participant advertisers. For advertising areas with larger numbers of advertising spaces, this may cause the advertising area to extend beyond the edges of the average output device or display screen 306 associated with remote computer 130. In such cases, participant advertiser application interface would generate vertical and/or horizontal scroll bars as are well known in the art, thus allowing visitors to the webpage housing the advertising area to scroll across the advertising area. A limitation with this solution is that all advertising spaces will not appear on screen simultaneously, and some may not be seen at all. As visibility is critical to the effectiveness of advertising, those advertising spaces in the top left corner of the advertising area will be of much higher value because they will always appear in the webpage as it initially loads without the need for a visitor to scroll. Another solution to this problem is using a mouse-over feature, as is well known in the art, to generate an enlarged image of the content within the advertising space over which a visitor's input device, such as a cursor, is placed. Thus, as a visitor moves his or her mouse or input device across display screen 306, larger images of the content within the individual advertising spaces will be temporarily generated on screen. Alternatively, larger-images might be generated when the content displayed upon a particular purchased advertising space is selected. This solution will prevent the need of using scroll bars to extend the advertising area beyond the screen boundary in most cases. If advertising space size is still a concern to a participant advertiser, they can always purchase multiple advertising spaces in a block and then submit content designed to extend over the entire block. This may be a very effective tool in that the participant advertiser's content would then appear much more prominently than the content of others using only a single advertising space.

In addition to image and text, in some embodiments, the advertising space can house music or video files such that a sound or video is played through an output device 306 of a computer 300 used by the visitor to the webpage when that user's input device, such as a mouse cursor, is positioned over the advertising space. Because the files associated with such content are larger, the host may require an additional content fee above and beyond the price of the advertising space. This content fee would not go into an escrow account associated with the advertising area, but would rather be kept by the host, regardless of whether a reserve is met. Finally, advertising spaces may also include embedded hyperlinks, such that, when the advertising space is clicked on by a visitor to the website, the visitor's application interface is redirected to the website address specified by the hyperlink. In this fashion, a participant advertiser may redirect visitors to its own website, for instance, so as to shop for its products, read the content of its blog, etc. Advertisement system application 210 provides an input mechanism in association with step 536 to receive the hyperlink content.

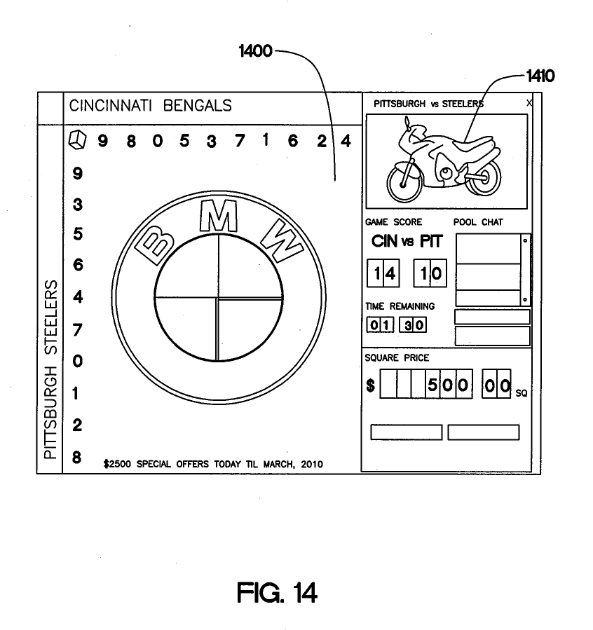

Once the content is received 538, application 210 screens it 539 to be sure it conforms to the guidelines of system 100. For instance, system 100 may reject pornographic or demeaning content. In some cases, an advertising area may have certain specific content guidelines that must also be conformed to. For instance, there may be a rule against sound or movie files being embedded within the advertising spaces, or perhaps all images must be of a red or green nature to celebrate the holidays, etc. In some embodiments the content check may be a spot check performed manually by the host, or this may be done as a secondary check in addition to the automatic check performed by application 210. In any event, if the content is rejected 540, application 210 requests content again 536. Until acceptable content is provided, the advertising space will remain blank, or will contain whatever content it had at the initiation of the advertising area. In some cases, a new advertising area may be created with an initial global image, such as that shown in FIG. 14. As advertising spaces are purchased, this image may be replaced by the content supplied by individual participant advertisers. If application 210 accepts the content from the participant advertiser, it then displays the content on the appropriate advertising space(s) 550 and the advertising area will reflect this when the webpage is reloaded. Finally, in cases where coupons or stored value cards were offered or earned as a result of the advertising space purchase, those coupons or stored value cards are delivered. This delivery may be in electronic form, such as by email, or by regular mail.

FIG. 6 provides an example of the process followed to secure secondary advertising, and continues from step 418 shown in FIG. 4. Two levels of advertising that may be present within multiple party advertisement system 100 have now been discussed, namely, a first level of advertising involving a sponsor advertising its products or services through a sponsored good or service promotion, and a second level of advertising wherein participant advertisers purchase advertising spaces and display advertisements within those spaces. A third level of advertising in multiple party advertisement system 100 is referred to as secondary advertising. Secondary advertising involves advertisers who are not necessarily interested in purchasing the sponsored good or service, but rather are interested in the audience of participant advertisers that the sponsored good or service might attract. Thus, the secondary advertisers purchase advertising on the webpage housing the advertising area, but along the periphery or otherwise outside of the advertising area, in hopes of attracting participating advertisers or other visitors through the secondary advertisement.

The most common form of a secondary advertisement is a click-through advertisement, which is well known in the art. A click-through advertisement is typically comprised of an image with an embedded hyperlink that, when clicked on, redirects the visitor's browser application to a website hosted by the entity sponsoring the advertisement. Each time such a click is performed, a tally is taken, such as by advertisement system application 210. In the exemplary embodiment, there is no cost for a secondary advertiser to post a secondary advertisement on a webpage housing an advertising area. Rather, the secondary advertiser is charged a fee each time the secondary advertisement is clicked on. In some embodiments, there may be a follow-through procedure whereby the secondary advertiser is charged an additional fee for re-directs that result in a sale on the secondary advertiser's website. As will be seen, in the illustrated embodiment, revenue or portions thereof from the secondary advertisements may be distributed among the participant advertisers. In other embodiments, secondary advertisements may also take on other forms, such as pop-up advertisements, video advertisements, interstitial advertisements, floating advertisements, wallpaper advertisements, or other known concepts.

As previously discussed, secondary advertisements may come from a pool of secondary advertising, and can cycle such that they appear on different webpages housing different advertising areas, or they may be randomly selected by application 210 to be placed on a particular webpage until the corresponding advertising area is dissolved. Alternatively, secondary advertising for each webpage may be supplied through a third party that houses a warehouse of secondary advertisements from various secondary advertisers. However, as disclosed in FIG. 6, the exemplary embodiment involves placement of secondary advertisements based on requests from secondary advertiser server 140 to advertisement system server 110. Once such a request is received 602, advertisement system application 210 interprets the request to determine whether the secondary advertiser wishes the secondary advertisement to be placed on a webpage corresponding to a particular advertising area 603. If so, application 210 causes the secondary advertisement to be placed on that webpage somewhere along the periphery of the corresponding advertisement area 640.

There are many reasons why a secondary advertiser might want placement alongside a particular advertising area. Advertising areas associated with particular future events are more prone to draw visitors, whether they be potential participant advertisers or simply guests. Thus, if the secondary advertiser's goods or services are also associated in some way with that future event, they may prefer placement around that particular advertising area. For example, advertising area 1000 of FIG. 10, which is associated with the Indianapolis 500, would likely draw visitors interested in automobile racing. Thus, a secondary advertiser such as Napa Auto Parts or Autozone, which cater to such enthusiasts, might want advertisement placement on the corresponding webpage.

Of course these companies could also elect to be participant advertisers and place advertisements within the advertising area itself, but they may prefer not to be constrained to the dimensions of the available advertising spaces. Typically, there is no cost for listing secondary advertisements in the preferred embodiment unless they begin to have an effect, such as through redirecting visitors to the secondary advertiser's website. Alternatively, the system host may choose to require additional fees to be paid by secondary advertisers. Finally, secondary advertising gives advertisers an opportunity to position advertisements on a webpage even after the deadline has passed for the corresponding advertising area, or after all advertising spaces have been filled. Such a placement might be particularly desirable as it is more likely to have high levels of viewership than a webpage housing an advertising area that fails to meet its reserve. Whether an advertiser wishes to interface with advertisement facilitation system 100 as a secondary advertiser, a participant advertiser, or both will depend on the particular needs and interests of the advertiser.

In the case where a request for a secondary advertisement does not specify a particular advertising area, system application 210 will endeavor to place the secondary advertisement so as to further the goal of placing at least some secondary advertisements on each webpage housing an advertising area. As explained above, in the exemplary embodiment, revenue from secondary advertising is distributed to the participant advertisers as a means of providing them with an additional incentive to participate in system 100. Thus, it is desirable to distribute the secondary advertisements evenly, with emphasis on those advertising areas that have the highest level of participant advertiser involvement where necessary. To achieve this goal, system application 210 will place the non-specific secondary advertisement on the webpage corresponding to the advertising area having the fewest secondary advertisements along its periphery 620. However, where there is a tie and more than one advertising area have the same lowest number of secondary advertisements 605, application 210 will post the secondary advertisement 640 on the webpage corresponding to the most populated advertising area 630, so as to distribute secondary advertisement revenue to the most participant advertisers. In other embodiments, a non-specific secondary advertisement may be placed along several different advertising areas concurrently.

Once the secondary advertisement placement is complete, as shown on FIG. 6, any user or visitor may click on the secondary advertisement 650. When this occurs, advertisement system application 210 records the click 660 and associates it with the particular webpage where the click occurred for purposes of determining distribution of the associated revenue. Thus, in cases where a single secondary advertisement appears on a multitude of webpages within advertisement facilitation system 100, the revenue associated with a click on that secondary advertisement will only be distributed to those participant advertisers who hold an advertising space within the advertising area corresponding to the webpage where the click occurred. In short, there is more revenue potential, and thus more incentive, for participant advertisers to participate in more popular, longer-running advertising areas in this embodiment.

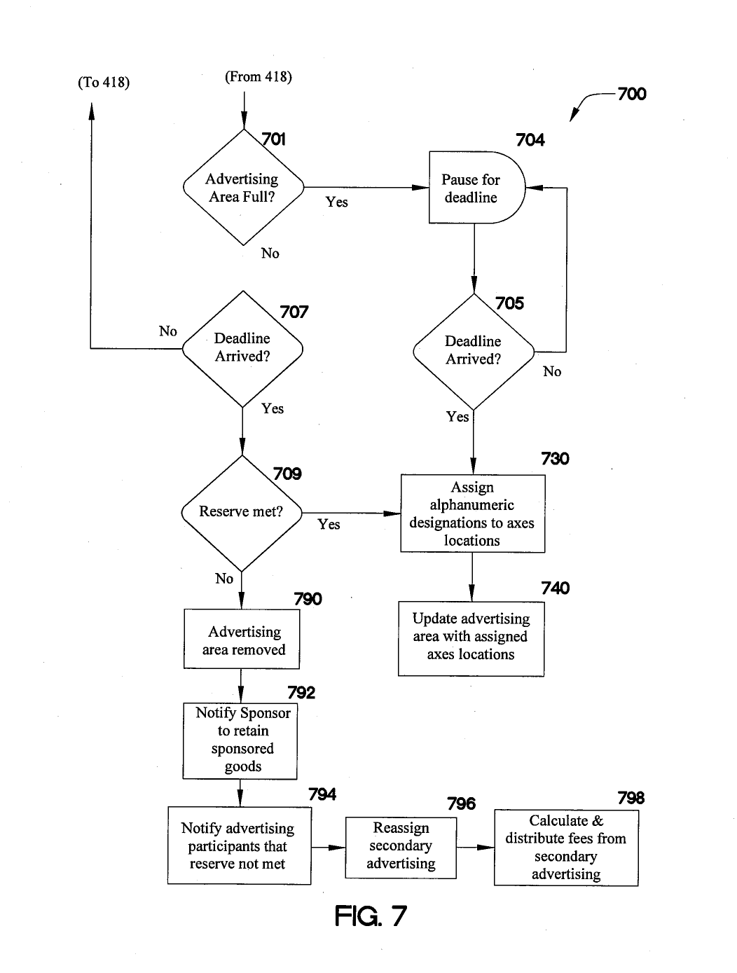

Turning to FIG. 7, as multiple party advertisement system application 210 continues to solicit for participant advertisers (step 418 of FIG. 4), it will periodically check to see whether all of the advertising spaces in a given advertising area have been purchased, i.e., the advertising area is full 701. If the advertising area is not full, system application 210 will check to see if the deadline has arrived 707. If the deadline has not arrived and the advertising area is not full, system application 210 will continue to attempt to draw participant advertisers to the advertising area 418. If the advertising area is full and the deadline has not arrived, system application 210 will enter a hold pattern 704 with respect to the advertising area until the deadline has arrived 705. In some embodiments, advertisement facilitation system 100 may provide for a trigger whereupon, when the last advertising space within an advertising area is purchased, or when the deadline arrives, system application 210 no longer directs participant advertisers to the advertising area.

As depicted in FIG. 7, the exemplary embodiment follows two paths at deadline arrival depending on whether or not the advertising area is full. Obviously, if the advertising area is full, any potential reserve has been met, so step 709 is not required. However, if the advertising area is not full when the deadline arrives, system application 210 checks to see if the reserve for the advertising area was met 709. If not, according to the exemplary embodiment, the webpage housing the advertising area will be disbanded or the advertising area will otherwise be removed 790 without waiting for the future event. In this case, system application 210 will notify the sponsor that the reserve was not met, at step 792, such as by sending a message through the network to sponsor remote computer 120, and the sponsored good or service will not be distributed. In a similar manner, system application 210 will then notify the participant advertisers that have purchased advertising space(s) within the advertising area that the reserve has not been met by sending messages to participant advertiser remote computers 130, and will credit them the amount paid for the advertising space(s) at step 794.

As shown, system application 210 will then reassign any secondary advertising 796 from the advertising area to alternative placement advertising areas. In cases where a secondary advertiser specifically requested advertising on the advertising area where a reserve has not been met, system application 210 will send a message to that secondary advertiser's secondary advertiser computer 145 inquiring whether the secondary advertiser would like to continue posting the secondary advertisement on the alternative placement advertising areas. If not, the secondary advertisement will be pulled. Finally, system application 210 will calculate the total fees collected from secondary advertising specific to the now-disbanded advertising area, and will distribute this amount evenly among the participant advertisers that had purchased advertising spaces thereon 798. Thus, according to the exemplary embodiment, even in cases where the reserve is not met, participant advertisers have an incentive to participate beyond the ability to place their content.

In alterative embodiments, there may not be a reserve associated with a particular advertising area. This may be a decision made by the sponsor. In such cases, when the deadline arrives, the un-purchased advertising spaces are assigned to the sponsor. This allows the advertising area to proceed until the future event, and allows for the distribution of the additional secondary advertising revenue that will develop as a result. If a participant advertiser has purchased the advertising space that is determined to be the resultant advertising space, that participant advertiser will be entitled to receive the sponsored good or service. However, if the resultant advertising space was not purchased, and was assigned back to the sponsor, the sponsor will simply retain the sponsored good or service. What becomes of the revenue from the purchase of the advertising spaces that did sell, in such a case, can vary in different embodiments. However, in some cases, it would simply be credited back to the participant advertisers in the same manner as if there were a reserve and it was not met.

Once the deadline has passed, if the reserve is met or if there is no reserve, system application 210 will randomly assign or otherwise reveal the alphanumeric designations for the axes location that correspond to the alphanumeric statistics associated with the advertising area 730 and then update the advertising area as it appears on the webpage 740. The passing of the deadline for accepting requests for advertising spaces and the assignment of the randomly-generated axes designations need not occur at the same time, though this is preferred. This is because, as will be explained, the assignment process may change the value of the advertising spaces. It would be undesirable to encourage participant advertisers to wait until the assignment has occurred to purchase advertising spaces, i.e., once their value is more clear. Thus, for those advertising spaces that initially have cloaked axes designations, it is preferred that the designations be revealed only after the deadline for purchasing spaces has passed.

For an example of the assignment process, we return to the example of FIG. 9. The letter designations of the axes locations used to identify advertising spaces for the purpose of purchasing those spaces would be replaced with numeric designations 0-9 in any random order. System application 210 may assign the numeric designations in any random order. In other embodiments, as discussed above, the axes locations may have been labeled with designations corresponding to the selected alphanumeric statistics from the start. In that case, nothing will change at the deadline other than that no more advertising spaces may be purchased. FIG. 10 provides a hybrid example where one axes is already labeled with its final designations, whereas the other axes, corresponding to the pole positions of the Indianapolis 500, will now be assigned numerical designations in random order.

Depending on the future event(s) and the controlling statistics, steps 730 and 740 may immediately change the value of the individual advertising spaces. For instance, the advertising space defined as “c-c” within advertising area 900 may now become advertising space “3-7”. Originally, this space was not toward the center, and had a lower price. Now, given that the future event is a football game, and scores of such games are more likely to end in a 3 or a 7, this space has greater value than many of those that were originally priced higher. This phenomenon will create a new market which involves trading advertising spaces. Participant advertisers that may have paid less for an advertising space may now be holding a more valuable asset and may wish to trade it with another participant advertiser, or sell it outright. Though not specifically depicted, system application 210 can easily accommodate such requests based on the functionality previously disclosed. The rules of a given advertising area may dictate whether trading advertising spaces is allowed, and whether the content associated with those spaces is also traded or left in place.

Once the deadline has passed and the axes designation assignment process is complete, system application 210 checks for results from the future event 801, 802, until it is complete and the controlling alphanumeric result is available. This information may be manually entered into advertisement system administrator computer 114, or may be sent to advertisement system server 110 though the network by a third party. In some embodiments, as discussed further below, system application 210 may provide updates to the future event while the event is in process. Furthermore, in cases where the future event is not a discreet event, but rather one that occurs over a period of time, such as a sporting event, there may be interim awards assigned to and distributed based upon the state of the alphanumeric statistic at different points during the future event. This is also further disclosed below.

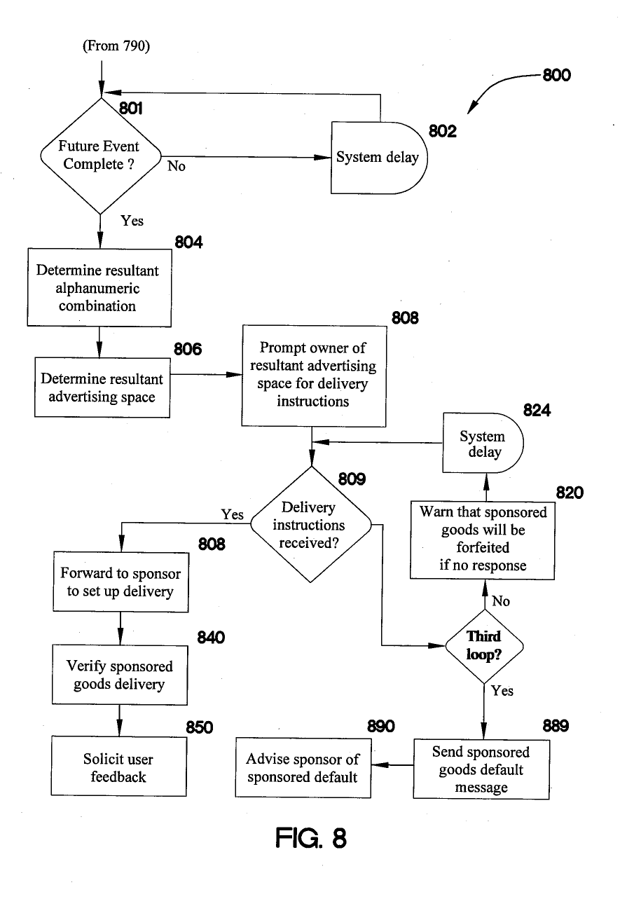

Using the results obtained from the future event, system application 210 determines the winning alphanumeric combination at step 804 and, in turn, the resultant advertising space, at step 806. System application 210 then notifies the participant advertiser who has purchased the resultant advertising space that its advertising space is the winner at step 808, and checks to see whether the participant advertiser's account includes delivery instructions at step 809. If such instructions are available or received upon request, system application 210 forwards this information to the sponsor, at step 830, for delivery of the sponsored good or service, such as by sending a message through the network to sponsor remote computer 120. If they are not available, system application 210 sends messages to the participant advertiser warning them that the information is needed in order to deliver the sponsored good or service at step 820. After a reasonable number of attempts are made to obtain delivery information, if no response is received, system application 210 will declare the sponsored good or service defaulted and notify the participant advertiser, at step 889, and sponsor, at step 890, of this result. Assuming the delivery instructions were available and provided to the sponsor, after a reasonable period of time, system application 210 sends a message to the participant advertiser that purchased the resultant advertising space to verify that the sponsored good or service was received 840. In cases where the sponsored good or services is simply a stored value card, or some certificate of credit that can be sent electronically, such as through email or over the network, the delivery/verification steps of FIG. 8 are not required.

Regardless of the nature of the sponsored good or service, after a certain time, system application 210 requests that the participant advertiser solicit feedback at step 850 that may be used to encourage other participant advertisers to buy advertising spaces in other advertising areas. The advertising area corresponding to the now completed future event may be left in place or may be disbanded.

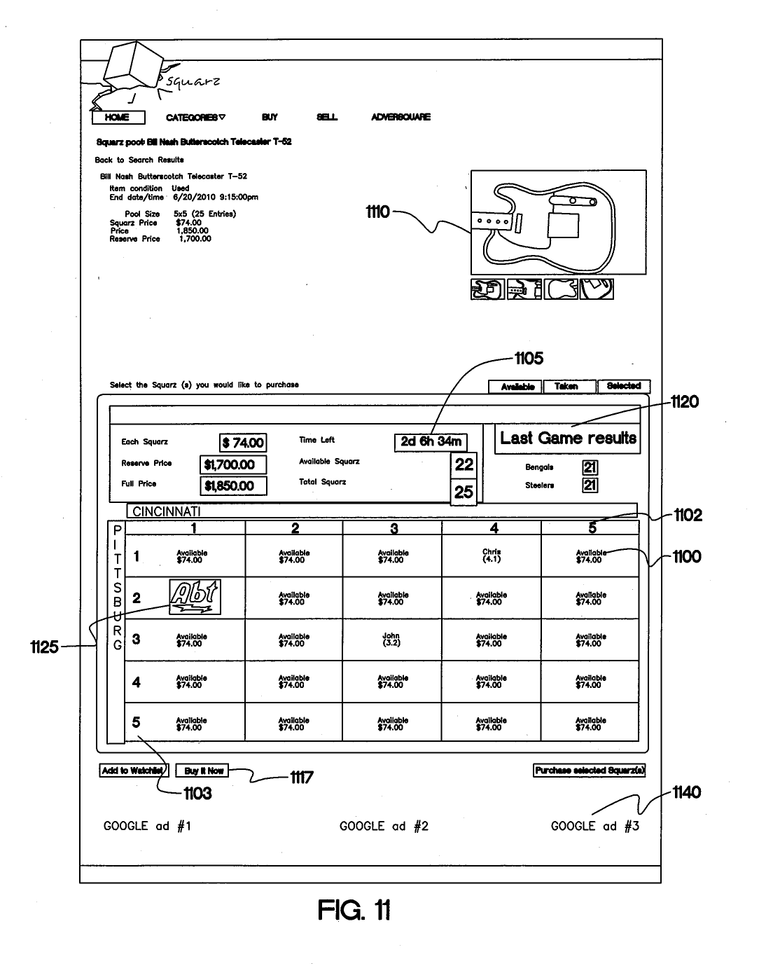

Now that the full life cycle of an advertising area according to an exemplary embodiment has been disclosed, a few examples of advertising areas are provided to show additional functionality and arrangement. FIG. 11 shows a screen shot of a webpage featuring advertising area 1100, and provides an example of use of advertisement facilitation system 100 by a sponsor that may be an individual or a small retailer wishing to use system 100 to sell a single item. In this fashion, advertisement facilitation system 100 functions principally as a sales vehicle similar to an online auction, but with the additional utility an incentive of facilitating multiple party advertising and potentially rewarding a sponsored good or service. The item, in this case, is depicted as sponsored good or service 1110, and is featured at the top of advertising area 1100 along with certain descriptive information. This provides an example of how the sponsor may use advertisement facilitation system 100 for its own advertising, by providing multiple pictures of the sponsored good or service, and a website address where visitors to the webpage can get more information.

Advertising area 1100 has been assigned a football game between the Cincinnati Bengals and the Pittsburgh Steelers as a future event. Immediately above advertising area 1100 is control box 1120, which is used by application 210 to provide various details relating to the advertising area. In this case, system application 210 provides a ticker 1105 showing the time remaining until the deadline, lists the final score corresponding to the last time the two teams met, lists the available advertising spaces, the advertising space price, the reserve, and the full price of the sponsored good or service at retail. In other cases, more or less information will be disclosed. The ticker 1105, which takes various forms throughout other embodiments, may display various near real time statistics relating to the future event, and may even show delayed video feeds relating to the event on screen. In many cases, where there is a reserve it will be provided as a number of advertising spaces that must be sold, rather than a dollar amount. However, given this scenario, it can easily be determined that 23 of the 25 total advertising spaces must be sold (at a price of $74 each) in order for the reserve to be met. At this point, only three advertising spaces have been purchased, and only one participant advertiser has elected to submit content, which is shown in advertising space 1125.

In the example of FIG. 11, the space price has been set to match the full retail price of the sponsored good or service. Thus, if the advertising area sells out, the sponsor will receive the full retail price. However, at most, the sponsor will only lose $148 off of the retail price based off of the established reserve (i.e, if 23 advertising spaces sell.) Furthermore, by listing a “buy it now” feature through button 1117, a visitor to the website may elect to purchase the sponsored good or service outright at the full retail price of $1850, thereby ending the sale at that point. In a case of termination, the advertising area would be disbanded as per the description listed above when a reserve is not met. In other cases, the “buy it now” feature becomes an “I still want it” feature, where a duplicate of the sponsored good or service may be purchased by any of the participant advertisers that did not receive the sponsored good or service as a result of having purchased the resultant advertising space. In this case, the system may offer the sponsored good or service at a special discount rate to such participant advertisers.

Also of interest in FIG. 11 is that axes 1102 and 1103 have already been labeled with numeric designations corresponding to the governing alphanumeric statistic, which is by default, the final score of the future event. Typically, when a 5×5 advertising area is provided and the alphanumeric possibilities are of a 10×10 nature, it is assumed that two numbers will be assigned to each axis location. This is yet another method to control the size of the advertising area, which may be desirable so as to increase the size of the advertising spaces, as discussed above. Thus, in this case, advertising space 1125 is associated with the alphanumeric designation 2, 1, which means if Pittsburgh's final score ends in a 3 or 4, and Cincinnati's final score ends in a 1 or 2, advertising space 1125 will be the resultant advertising space (assuming the reserve is met). Finally, FIG. 11 features some typical secondary advertising along the bottom of advertising area 1000, such as secondary advertisement 1140. These secondary advertisements have been logically placed, either by system application 210 or per the request of the secondary advertiser, so as to be associated with an advertising area featuring a sponsored good or service similar to the goods sold by the secondary advertisers. Visitors or participant advertisers who use the selection criteria created by system application 210 to find sponsored goods or services relating to musical instruments are likely to be directed to this webpage. Thus, it makes sense for secondary advertisers selling such material to advertise here.

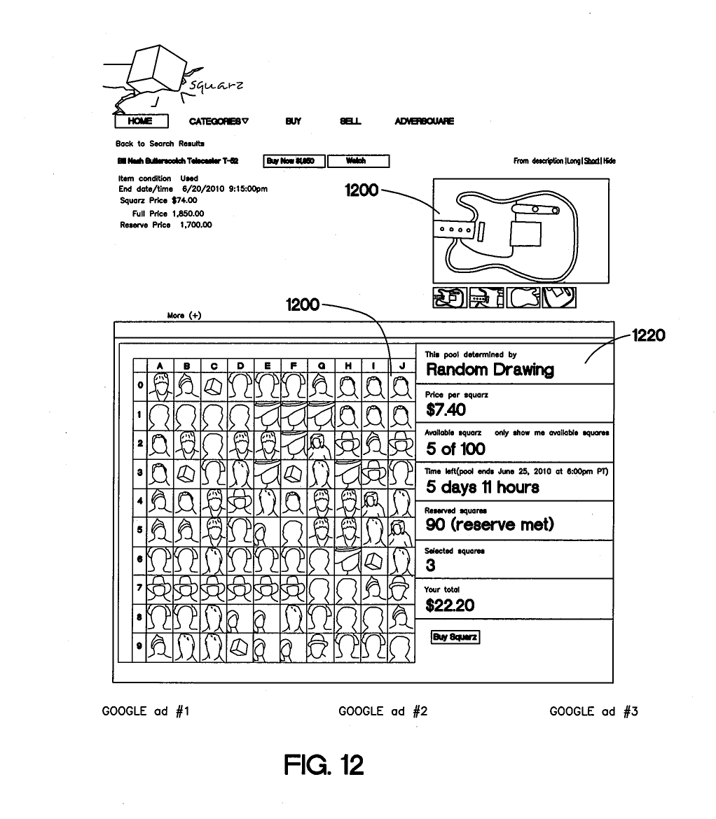

FIG. 12 shows a webpage featuring advertising area 1200. In this case, control box 1220 has been relocated to the side, and advertising area 1200 has expanded to a 10×10 size, thus offering 100 advertising spaces. Sponsored good or service 1210 is the same as sponsored good or service 1110, but the advertising space price has been set to variable. As discussed above, the price could vary based on any number of things, such as time remaining as discussed above. As the retail price of this sponsored good or service is $1850, it is most likely that the majority of advertising spaces sold for a price much higher than the price presently listed in the control box of $7.40, because at this price the advertising area would only generate $740 versus a much higher retail price. More likely, based on the reserve being met, system application 210 has lowered the price of the remaining spaces per direction from the sponsor in an attempt to completely sell out the advertising area. As illustrated by FIG. 12, a particular participant advertiser is now in the process of purchasing three of the remaining five advertising spaces.

FIG. 12 also works to demonstrate that participant advertisers in some instances, will be individuals wishing to submit personalized content. This content may still be advertisements in that the content may include a hyperlink to a website address featuring the individual's blog, Linkedln webpage, personal webpage, or other such business or social networking information. Moreover, all of the features described above still work to incentivize participation by such individuals as participant advertisers. Participant advertisers may also receive a return on their investment in the form of advertising revenue from the secondary advertisements. Also notable in FIG. 12 is that the future event may simply be a random drawing. Thus, at the appropriate time, system application 210 will randomly generate a number and letter that will be used to determine the resultant advertising space.

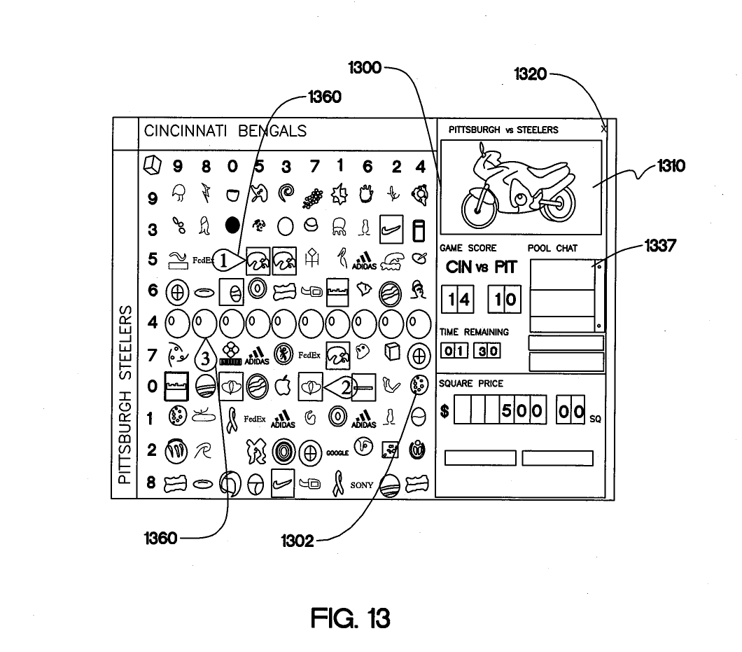

FIG. 13 depicts yet another example, showing advertising area 1300 and corresponding control box 1320. Sponsored good or service 1310 is displayed within control box 1320. Similar to advertising area 1100 of FIG. 11, advertising area 1300 is associated with the Bengals vs. Steelers football game. However, in this case, the game is already underway. As shown in control box 1320, the score is Cincinnati 14, Pittsburg 10, and there is only 1 minute and 30 seconds left. Unless the score changes in that time, advertising space 1302 depicting the Wikipedia icon will be the resultant advertising space, and the participant advertiser that purchased that space will receive sponsored good or service 1310.

FIG. 13 is useful in pointing out several aspects. First, it provides an example of an advertising area in its advanced stages, where the axes designations have been revealed, and the future event is nearly complete. The advertising space price is still shown, though it is unclear if this was the price paid for all advertising spaces or merely the initial price. As it is unlikely the sponsored good or service retails at $50,000, most likely it is the latter. In any event, all of the 100 advertising spaces have been purchased, and filled with familiar icons of various well-known corporate or private entities. Control box 1320 also features a chat feature 1337, through which participant advertisers may post messages. Depending on the settings for the advertising area, the chat feature could also allow visitors without an account to post such messages. Finally, advertising space markers 1360 indicate that this particular advertising area was setup so as to distribute interim awards or bonuses to resultant advertising spaces, and the markers 1360 identify the advertising spaces that are entitled to receive the interim award or bonuses.

The chat feature discussed in the preceding paragraph can take on various forms to allow interaction between participants. In some embodiments, it may also be connected to social media to allow TWITTER posts, FACEBOOK interaction, or participation through other media. For example, a display area can be placed directly below the advertising area or discount board. Information or “details” about the sponsor or the sponsored good can appear on one side of the screen, while a separate window that is connected to a social media platform can appear on the other side of the screen. The separate window can be generated by the system application 210 when the user selects a “share” feature, and is directed at drawing more people and attention to the advertising area. By posting a link on a participant's wall (such as a Facebook wall), other potential participants may be attracted to the advertising area. The social media window can also be used to address questions about the merits of the associated sponsored service or other subject.

Depending on the nature of the future event, interim awards or bonuses may be set up to provide further incentive to participant advertisers. For example, if the future event is a football game, and the governing alphanumeric statistic is the last digit of each team's final score, this statistic can also be recorded and assessed at the end of each quarter of play (or any time or number of times in between), but allowing for additional advertising spaces to be rewarded. Though only the resultant advertising space determined by the final score will receive the sponsored good or service, the interim awards or bonuses may be distributed to the advertising spaces identified by the score at the end of each quarter. For instance, perhaps the participant advertiser owners of the advertising spaces identified by advertising space markers 1360 will receive a refund of their advertising space purchase price. Essentially, any number of interim awards can be established and distributed, so long as the rules are set forth prior to the initiation of the future event.

FIG. 14 provides an example of an advertising area very much like advertising area 1300 of FIG. 13, with the obvious difference being that a single participant advertiser, namely Bayerische Motoren Werke, has purchased the entire advertising area 1400. Though it is conceivable in certain embodiments that a single participant advertiser might purchase an entire advertising area from an independent sponsor, the more likely case is that a sponsor decides to use the sponsored good or service as an award in a larger promotional event, and thus assumes the role of sole participant advertiser. For instance, sponsored good or service 1410 is a motorcycle manufactured and sold by BMW. As the sponsor, BMW had decided not to sell the sponsored good or service through advertisement facilitation system 100, but rather to award it, presumably for free, to a person connected with the resultant advertising space. Such a promotion can be set up independent of advertisement facilitation system 100, and may involve awarding advertising spaces to individuals through a local or national advertising campaign or sweepstakes. In such a case, there is no advertising space price, because all of the advertising spaces remain with the sponsor. However, as the participant advertiser and sponsor, BMW is only offering through the promotional campaign the opportunity to win the sponsored good or service. The rights to advertise content through the advertising space, and presumably any revenue from secondary advertising due the advertising space, remains with BMW.

In other embodiments, the sponsor may take an even more active presence or role in the system by hosting the advertising area and associated functionality on its own electronic storefront through its own, or an independent website. The website may or may not reside on the advertisement system server 110, and may reside on the sponsor remote computer 120. In such cases, the system application 210 may still operate on the system server 110, or may be licensed and run directly by the sponsor. In such tailored environments, there might be no secondary advertisements, but rather the entire display generated by the system would be directed to the sponsor's goods and services, and the website would be branded for identification with the sponsor.

In similar embodiments, the sponsor could be a specific entity that has contracted with the system host to provide a tailored version of the system. For example, the sponsor might be a lottery commission that elects to offer a lottery game to users through the advertisement system application 210. In this case, the lottery would select the sponsored good, and would set the price for the purchase of advertising spaces. Revenue from the sale of the advertising spaces would go to the lottery commission. The sponsored good may be a cash prize or unclaimed property that has been seized or forfeited to the governing body that controls the commission. In another scenario, the advertisement system application 210 could be tailored to operate on networked wireless devices in bars or restaurants where play is conducted with other patrons at the bar or restaurant, or even at another bar or restaurant operated by the same entity filling the sponsor roll through similar wireless devices. In this case, the purchase of a food or drink item might result in the award of an advertising space. The patron could then submit content from their personal wireless device (the participant advertiser remote computer 130) or pull it in from a connection to the Internet to advertise on or otherwise adorn the awarded space. The sponsored good or service may be a free meal or entrée at the restaurant or bar, or some prize completely unrelated to the sponsor's venue.

In a similar scenario to that of FIG. 14, the sponsor could be a charity organization rather than a retailer. In this case, the sponsored good might be donated by a third party, or might be fronted by the charity, similar to the goods auctioned away in a typical silent auction. In this case, in exchange for purchasing advertising spaces, participant advertisers would receive a receipt identifying the percentage of the purchase that is tax deductible as a charitable donation. This receipt could be generated by the multiple party advertisement system application 210 and provided through the network to the participant advertiser remote computer 130. The ability to adorn advertising spaces with advertising space data will promote charitable donations in a manner similar to that of listing principal donors in the back of programs for theatrical performances. Most people like the recognition they receive from making the donation, and can receive that recognition by placing their name or information on the purchased advertising space.

Multiple party advertising facilitation system 100 could be adapted and used in various ways in combination with such promotional campaigns that extend beyond the boundaries of the network itself. For instance, given the scenario above where a sponsor has elected to purchase the entire advertising area 1400, the sponsor may associate advertising area 1400 with one or more of the sponsor's lower price commodity products or services. When sold, each of the associated commodity products or services may come with a code or identifier. Alternatively, the codes could be associated with gift cards or stored value cards for use in association with the sponsor's goods and services, wherein the cards contain an area that could be scratched away to reveal a code. The code may then be used by the purchaser of the products or services to interact with advertising facilitation system 100, and potentially be awarded an advertising space.

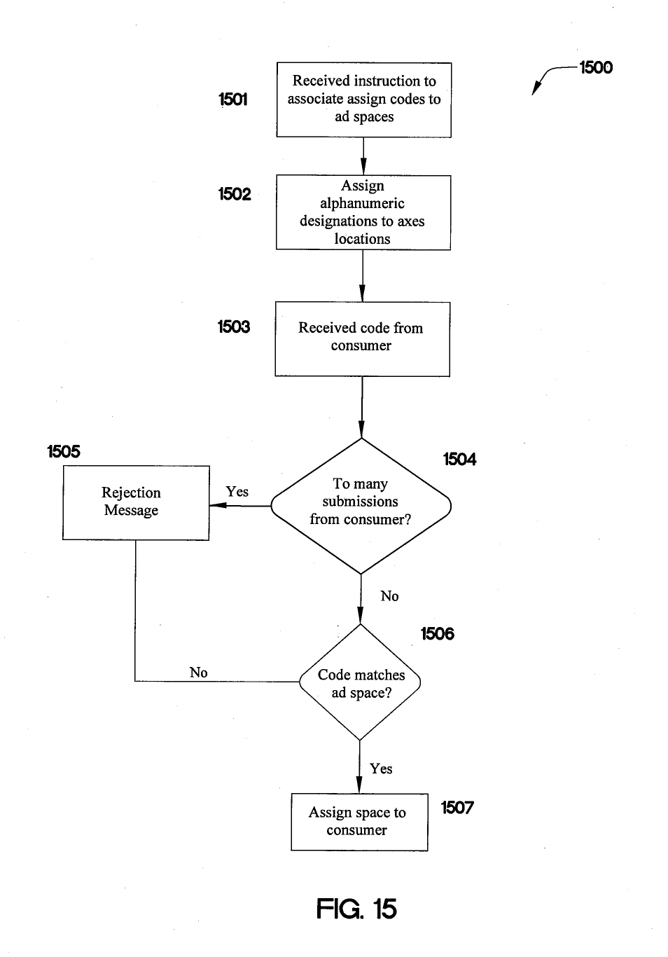

As an example, with reference to FIG. 15, perhaps a particular advertising area is sponsored by PEPSICO, and PEPSICO opts to display its own content across the full advertising area rather than individually sell or resell the advertising spaces which form the advertising area. Based on PEPSICO's instructions received from sponsor remote computer 120, at step 1501, advertisement system application 210 associates each advertising space with a particular code at step 1502. PEPSICO could then provide the codes corresponding to the advertising spaces in the advertising area on the inside of bottle caps of certain bottles of PEPSI. The bottles could also provide instructions on how the purchasing consumer can access the advertising area. Thus, in order for someone to potentially receive a code, they must purchase a PEPSI and remove the bottle cap. Consumers that purchase a PEPSI containing a code may then interface with advertisement system application 210 through the network using a device such as participant advertiser remote computer 130 to transmit the code to advertisement system server 110 at step 1503. If advertisement system application 210 identifies the code as corresponding to a particular advertising space within the PEPSICO advertising area, the consumer will be assigned that advertising space at step 1507.

Alternatively, the code need not be assigned to a particular advertising space. Rather, advertisement system 100 and system application 210 would receive the code and give the database having one or more predetermined codes therein, the application 210 would then compare the received code to one or more predetermined codes to determine whether the consumer is entitled to receive an advertising space. If a match occurs, then the consumer is assigned an advertising space, randomly or in some other fashion, or is allowed to select an advertising space, either before or after assignment of the alphanumeric designations occurs of the grid axis.

Codes could be accepted by advertisement system application 210 all the way up until the future event associated with the advertising area is complete, or system application 210 may refuse codes received after a pre-selected deadline. As explained above, this deadline may be before or after the grid axes are assigned alphanumeric designations. In some variations, a consumer holding a code associated with an advertising space may be able to post his or her own content within the advertising space just as a participant advertiser in the scenarios described above. However, it is likely that the sponsor will prefer to keep the entire advertising area as a single display for its own content, such as the PEPSI logo in the example above.

As above, in some variations, instead of a particular code being pre-associated with a particular advertising space, the code merely authorizes advertisement system application 210 to assign to the consumer the advertising space of his or her choice from among the remaining advertising spaces within the advertising area. In still other variations, only certain codes might be associated with advertising spaces. In this case, returning to the example above, PEPSICO could place a unique five-character alphanumeric combination on each of some 60 million different bottles of PEPSI. However, only 100 of the combinations would be associated with an advertising space in a ten by ten advertising area. Nevertheless, each consumer purchasing one of the 60 million bottles of PEPSI would theoretically have an equal chance to have selected a bottle having one of the 100 combinations of interest, thus potentially driving millions of visitors to interact with advertisement system application 210 through the network to determine the merit of their particular combination. Through this, advertising facilitation system 100 will have created significant viewership for the advertising area, which will likely result in higher revenues from the associated secondary advertisers. Advertising facilitation system 100 may allocate this revenue to the sponsor, the system host, the consumers with assigned advertising spaces, or it may divide the revenue among these parties in any fashion.

Notably, operation of advertising facilitation system 100 in this manner would also likely require advertisement system application 210 to execute a lock-out feature, such as depicted with step 1506 in FIG. 15, whereby webpage visitors are only allowed to enter a certain number of codes prior to their account being locked out of the advertising area. Otherwise, visitors might simply guess codes randomly without purchasing a PEPSI bottle.

In a slightly different scenario, the sponsor could offer the sale of a lower cost item through the advertising area instead of in the open marketplace. For example, a lower cost item such as a metallic decorative bracelet might be offered from a jeweler at a retail price. In exchange for purchasing one of the bracelets at the listed price, the user/participant advertiser receives the advertising space associated with an advertising area, wherein the sponsored good is a higher cost item offered by the jeweler, such as a necklace and earring set featuring precious stones. If the advertising space awarded to a user in exchange for purchase of the bracelet is the resultant advertising space determined as a result of the future event, that user will receive the necklace and earrings as well. Where an actual product is purchased in exchange for an advertising space, the lower cost item may be delivered via mail, or may require pickup from the sponsor. In some cases, pickup from the sponsor must be done within a certain period of time. In such scenarios, the sponsor will ultimately not have to provide all of the items because some of the purchasers will not show up. This allows the sponsor to offer them at a discount price. For those that do opt to pick up the item, it is a means to draw customers to the sponsor's store.

Another embodiment enabled by advertisement facilitation system 100, is for a sponsor to pre-purchase all of the advertising spaces, but leave the advertising area blank. This concept could also be operated directly by the system host with no sponsor involvement. Then, as advertising spaces are purchased by participant advertisers from the sponsor or system host, instead of posting content submitted by those participant advertisers, advertisement system application 210 “flips over” the purchased advertising spaces to reveal portions of a puzzle, first to the purchasing participant advertiser, and then, after a time, to all visitors to the webpage on which the area is displayed. This delay gives the purchasing participant advertiser a “sneak peak” at the advertising area with the new portion of the puzzle revealed. The puzzle might be a word or phrase, such that an interim award or bonus is offered to the first person to correctly guess and submit the complete word or phrase through the network to advertisement system application 210. When operated by a sponsor, the word or phrase may relate to the sponsor or its products or services, thus encouraging participant advertisers to research and learn more about the sponsor and its products and services. The embodiment could still include a sponsored good or service corresponding to a specific advertising space to be determined by a future event as described above.

This embodiment has the benefit of driving initial interest in the advertising area to compete for the interim award or bonus. Participant advertisers who think they are close to guessing correctly may pay significantly more for certain advertising spaces that they believe will reveal the clue necessary to solve the puzzle. Then, once the interim award or bonus has been distributed associated with the correct guess of the word or phrase, there is enough involvement in the advertising area that it is likely to meet its reserve, which will encourage further participation for the advertising area in hopes of receiving the sponsored good or service associated with the future event.

In still other embodiments, advertisement system application 210 further facilitates the resale and/or auction of advertising spaces once they are purchased by participant advertisers. This sale or auction may take place before or after assignment of alphanumeric designations to the grid axes, before or after the reserve is met, if any, and even after the deadline. However, all transactions must be finalized by the completion of the associated future event. Advertisement system application 210 may facilitate this transfer of advertising spaces by allowing a participant advertiser to select for the application 210 to display text within an additional bid entry box (not shown) within the control box. Similar to chat feature 1337 of FIG. 13, the bid entry box contains an area for participant advertisers to enter sale bids for advertising spaces they own, and for present or potential future participant advertisers to enter purchase bids for advertising spaces they want to acquire from other participant advertisers. Thus, by use of participant advertiser remote computer 130, present and potential future participant advertisers can interact with advertisement system application 210 through the network to buy and sell advertising spaces after those spaces have been initially purchased from the sponsor or from another participant advertiser. The resale of advertising spaces may or may not include any coupons or stored value cards that came with the initial purchase of those spaces.

This reselling concept could be conducted in a “buy-now” scenario, whereby a seller lists a price at which the square may be purchased directly, or through an auction format whereby the seller opens up the bidding at a set price and awards the advertising space to the highest bidder after a set time has expired. Alternatively, advertisement system application 210 could conduct the resale in an auction format, but allow a prospective purchasing participant advertiser to end the process by offering to pay a pre-designated “buy-now” price. Transactions of funds between participant advertisers could be handled by linking advertisement system server 110 to a third-party such as APTIVA or PAYPAL as known in the art, or could be handled directly by advertisement system application 210 using a point system, where the points are pre-purchased from multiple party advertisement facilitation system 100 by the participant advertisers. In the latter case, advertisement system application 210 would include an account management feature associated with each user profile created.

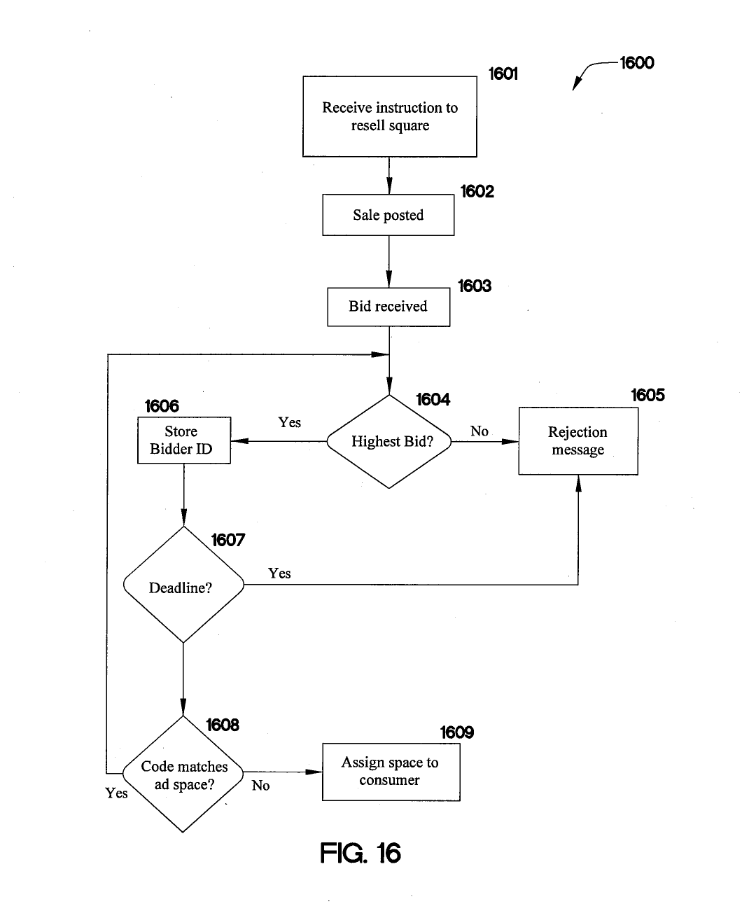

With reference to FIG. 16, a participant advertiser that has purchased a particular advertising space in a particular advertising area can choose to offer it for resale at step 1601. The participant advertiser sends instructions through the network to advertisement system application 210 to list the advertising space in the bid entry box as being available for bidding above a reserve price, and identifies to advertisement system application 210 that the space will go to the highest bidder above the reserve price at a set time such as 1 hour prior to initiation of the associated future event. Advertisement system application 210 receives these instructions, and transmits prompts to allow the application 210 to begin receiving bids from other participant advertisers at steps 1602 and 1603. At the appropriate time, advertisement system application 210 identifies the highest bidder, at step 1604, and reassigns the associated advertising space accordingly at step 1609. The new owner of the advertising space may or may not be allowed to submit new advertising content for the advertising space.

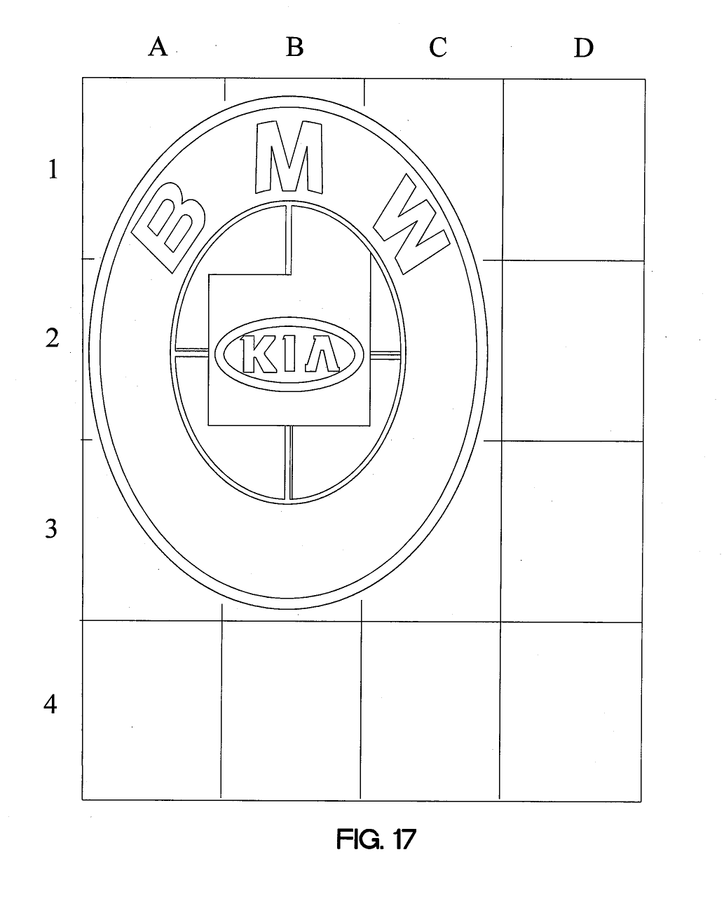

This concept would have particular utility in scenarios where a specific participant advertiser is interested in displaying content stretching over a set of contiguous advertising spaces as described above, but another participant advertiser has obtained an advertising space that blocks this from happening. For instance, with reference to FIG. 17, say advertising spaces A1, A2, A3, B1, B3, C1, C2 and C3 are owned by a first participant advertiser such as BMW in an advertising area having alphanumeric grid designations of 1-10 along a first axis and A-J along a second axis. Acquiring advertising space B2 could be of particular value to the first participant advertiser, so as to get a contiguous block. The owner of advertising space B2, such as KIA as shown in FIG. 17, thus, might offer the space for bid. Alternatively, in such a scenario, KIA might reach out to BMW directly through the chat feature of advertisement system application 210 as described above, and offer a direct sale that may or may not take place within the confines of advertisement facilitation system 100. While FIG. 17 depicts this scenario using corporate entities and logos, it could just as easily be two individuals seeking to display their social messages.

In yet another embodiment, advertisement facilitation system 100 allows consumers to cause advertising areas to be established, with certain pre-defined input from sponsors and/or the system host. From interface pages of a sponsor website or system, the customer of the sponsor could select a product or service as the sponsored good or service and instruct or select an option for advertisement system application 210 to construct an advertising area designed to sell that sponsored good or service through the advertising area in one of the various manners previously described. This option could be located on the sponsor website or system and be transmitted from the sponsor website or system to the advertisement system application 210. Typically, a sponsor would be involved at least to designate which of its products or services could be eligible for selection and incorporation into an advertising area, and to designate a price for the advertising spaces (or designate a coupon/offer and price associated with the discount spaces).

Where sponsors are involved, and the products are not purchased directly from the sponsor, such as by the system host, prior to association with an advertising area, the sponsors will likely want to pre-authorize their participation in a customer-instigated multiple party advertisement scheme through advertising facilitation system 100. Those sponsors that choose to participate may designate certain of their products or services as eligible for selection by a customer to be sold through an advertising space while other products or services will not be eligible. In addition, the sponsor may allow only a limited quantity of designated products to be selected and sold in this manner. Further, a sponsor may allow only certain preferred customers to select designated products and instigate a sale through an advertising area. Alternatively, the system host could purchase or hold in inventory the sponsored good or service such that the sponsor need have no involvement.

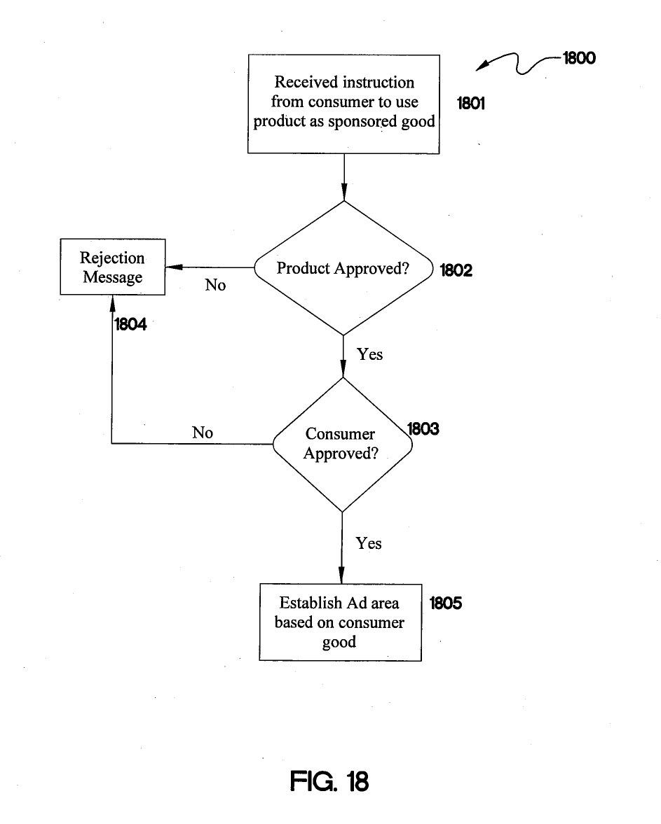

In practice, with reference to FIG. 18, a customer could be using a computer 300 to interact through the network with sponsor computer application interface 220 so as to view the sponsor's inventory. The customer identifies a product offered for sale through sponsor computer application interface 220, but instead of purchasing it from the sponsor, the customer indicates to sponsor computer application interface 220 a desire to associate the product with a new advertising space, at step 1801. Sponsor computer application interface 220 identifies availability of the product at step 1802, and that it is authorized to serve as a sponsored good or service in association with advertisement facilitation system 100. If so, sponsor computer application interface 220 signals advertisement system application 210 through the network, instructing it to set up the new advertising area and associate it with the selected sponsored good or service at step 1805. Here, the future event and other inputs may be defined by (1) the customer, (2) the sponsor, or (3) the system host.

A further enhancement of such an embodiment involves a private discount board or advertising area, where users not only select the sponsored good, but also select the additional participants through invitation. The invitations may be extended electronically, such as through social media, or in any other manner. Alternatively, the sponsor may send the invitations, via sponsor remote computer 120, to a list of its preferred clientele, or perhaps to those who have purchased additional items from the sponsor on account of their use of the advertising facilitation system 100.

In still other embodiments, there may be no sponsor at all. Rather, the system host would post certain things of value it has available or can access to serve as sponsored goods or services in yet-to-be-created advertising areas. In this case, participant advertisers could browse a list of available products or services on the system host's website, wherein all of the products or services may be selected to be associated with a new advertising area set up by advertisement system application 210 based completely on inputs from the participant advertiser that selects the product or service.

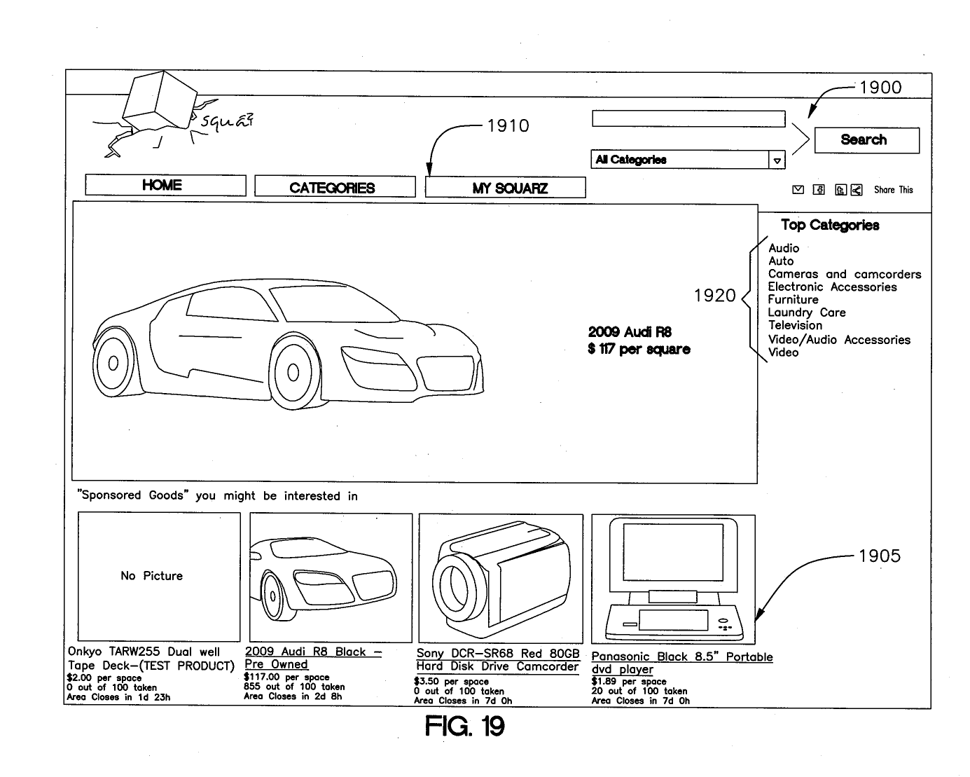

FIGS. 19-22b illustrate yet another embodiment of the present invention. FIG. 19 depicts a landing page 1900, which might serve as a home webpage for the host of the multiple party advertisement system application 210. As shown, the landing page 1900 features certain sponsored goods 1905 which are actively being sold through advertising areas. This provides yet another advertising option, namely for a sponsor to place their sponsored goods or services at the very highest point of visibility within the website. Alternatively, this placement might be used by the system host to help advertising areas meet their reserve requirements. FIG. 19 also shows function tabs along the top. For instance, the My Squarz tab 1910 might cause system application 210 to direct a visitor to a personalized webpage where only the advertising areas they are involved in are shown. Landing page 1900 also features several ways to use system application 210 to search for sponsored goods or services/advertising areas that are not immediately depicted. For instance, a visitor can type in a search term at the top left, or may select from the Top Categories menu 1920 at the right.

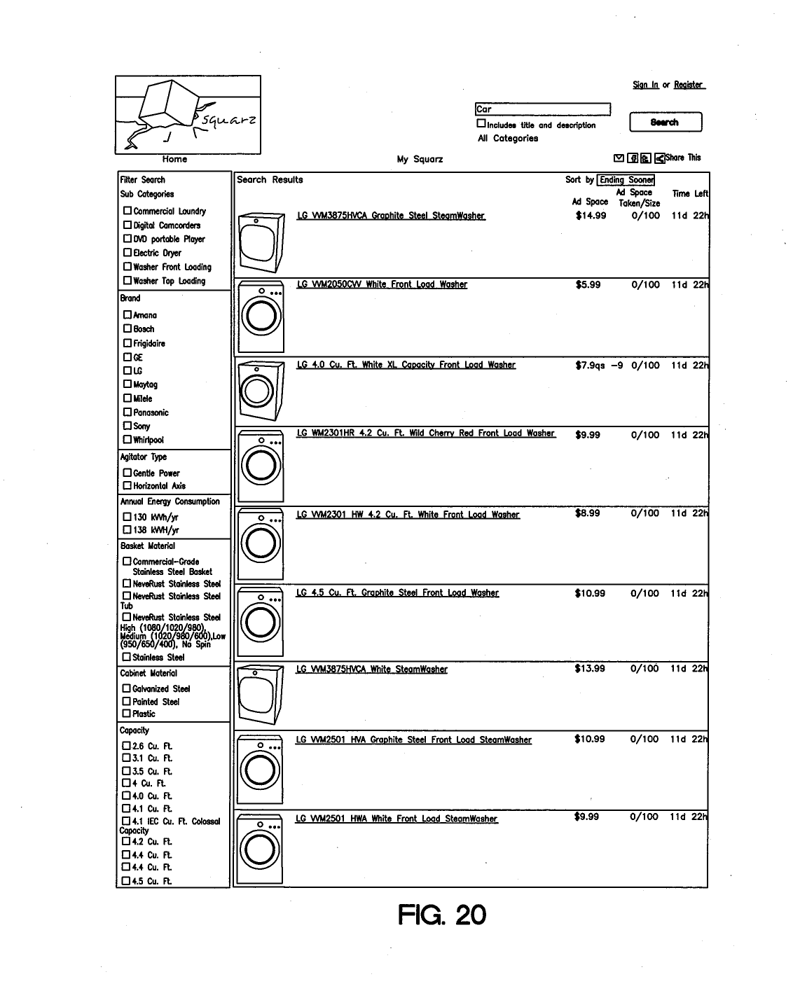

For example, in the illustrated embodiment, if a visitor selects the “Laundry Care” category from the menu 1920, multiple party advertisement system application 210 might provide a listing similar to that of FIG. 20. As shown in FIG. 20, a listing is provided of numerous laundry care products, each of which is the featured sponsored good in a different advertising area. System application 210 gives a short description and photo of the items, along with information relating to the current cost of an advertising space, the number of advertising spaces available, the total size of the advertising area, and the time until the deadline is to occur. In other embodiments, the listing might also, or alternatively, include data such as a description of the associated future event(s), the reserve requirement, or other information relating to the advertising area. In fact, as discussed in association with other embodiments above, visitors can also search by these attributes to arrive at a list similar to that depicted in FIG. 20 wherein the attribute searched for is the featured attribute to the left, and the sponsored good is simply listed in text to the right, or not at all.

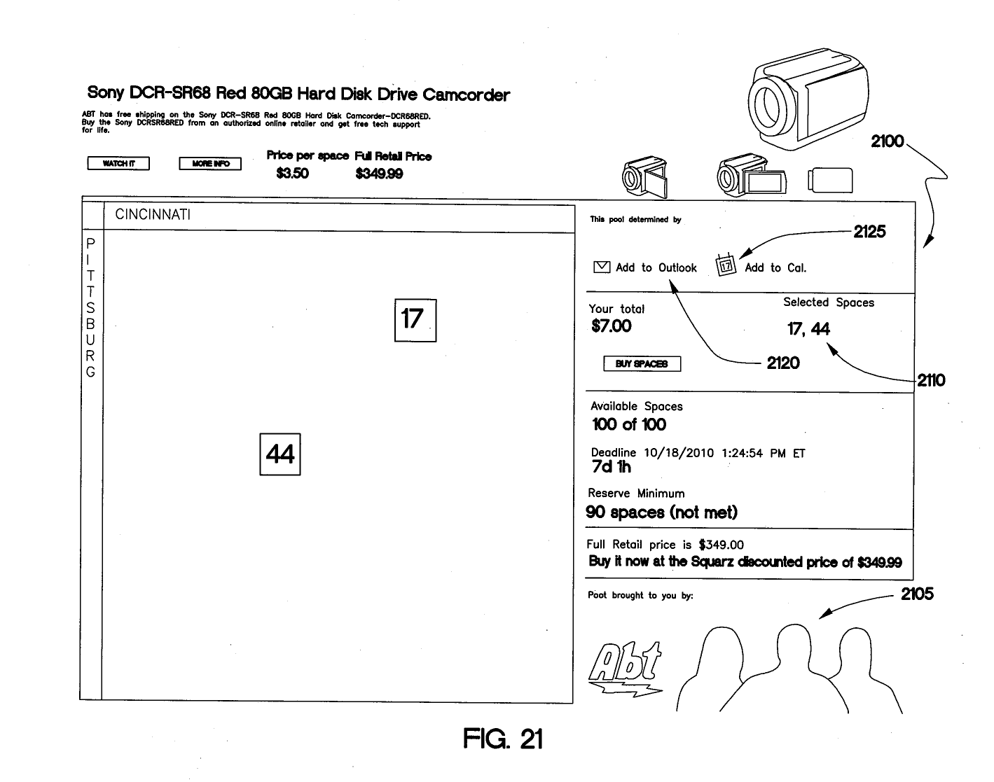

Should a visitor select one of the sponsored goods shown in the list of FIG. 20, multiple party advertisement system application 210 would display the associated advertising area, such as advertising area 2100 of FIG. 21. This is a layout similar to that of the advertising area of FIG. 12. However, this embodiment contains a few additional features. First, the sponsor is provided with sponsor area 2105 specifically set aside for it to identify itself. In this case, the sponsor is ABT. Second, the advertising area offers a mouse-over feature that highlights available advertising spaces as they are scrolled over with a cursor. When particular advertising spaces are selected, they are listed in the selected spaces region 2110. This is similar to a shopping cart feature. When the Buy button is selected, the advertising spaces denoted in the selected spaces region 2110 will be purchased by the participant advertiser. Finally, the advertising area of FIG. 21 provides “add to outlook” and “add to iCal” buttons 2120 and 2125, respectively. When selected, these options cause multiple party advertisement system application 210 to generate a calendar event, such as in a .icc file, associated with the advertising area. For example, the calendar event may cause OUTLOOK software on the visitor's computer to send the visitor a reminder at a certain point prior to the deadline, when the reserve is about to be met, etc. The particular details of the calendar event could be retrieved by system application 210 from the visitor after the buttons 2120 and 2125 are selected.

The transmitted display may also comprise a detailed description of the sponsored good associated with the advertising area of FIG. 21. For example, this description might immediately follow the view of FIG. 21, such that it comes into view as a user scrolls down below the advertising area. Though this information could be stored on advertisement system server 110, or be loaded from facilitator database 216, information of this detail may also be pulled in from sponsor remote computer 120. This allows the sponsor to maintain control of the sponsored good detailed description should any changes be required throughout the course of the advertising area display. This is best facilitated where there is a dedicated network connection between sponsor remote computer 120 and advertisement system server 110.

In other embodiments, multiple party advertisement facilitation system 100 is directed more toward advertising through the sale of discounted coupons or stored value cards in association with discount boards than to the display of individual advertising space data within advertising areas. As previously explained, a discount board is essential the same as, and functions in the same manner as, an advertising area, with the exception that discount boards are comprised of discount spaces rather than advertising spaces. Nearly all of the previous disclosure relating to advertising areas equally applies to discount boards. For example, a discount board is associated with a future event, and might be set up just like the examples provided in FIGS. 9 and 10. However, discount spaces do not necessarily allow for the display of data, such as advertising space data, submitted by the purchaser of the discount space. Thus, while the flowcharts provided in FIGS. 4-8 are equally applicable to discount boards, certain steps would not necessarily be performed, such as Step 538, wherein advertising space data is received from the participant advertisers.

Whereas the purchase of advertising spaces may be associated with the receipt of a coupon or stored value card, each discount space is associated with such a coupon or stored value card. Moreover, in most embodiments, the coupon or stored value card will have a temporary value exceeding the price paid for the discount space. For example, a discount space might be offered for ten dollars. In exchange for the purchase, the registered user receives the coupon associated with the discount space, which might be for $100 worth of merchandise purchased from the sponsor. However, the coupon expires after a fixed period of time, thus driving sales to the sponsor that would likely not have otherwise been made. It is also assumed that many of these coupons will not be redeemed. Further, the coupons might only be good for the purchase of clearance material that the sponsor is trying to move quickly. If the material is no longer available, the value of the coupon reverts to the price paid for the square, and is good for general merchandise from the sponsor. Alternatively, purchase of the discount space for ten dollars might result in the registered user receiving a stored value card worth $20 for any purchase through the sponsor, but only if purchased within a certain window of time. After the window expires, the stored value card would revert to the amount paid for the discount space.

In preferred embodiments, the system collects or receives feedback when the coupon is used, or when the discount card is used within its period of heightened value. This feedback may be delivered automatically via the sponsor remote computer 120 when a transaction involving the coupon or discount card takes place. For example, use of the coupon or discount card may require the sales clerk at the sponsor's store (or the user, if the purchase is online) to enter a code associated with the coupon or discount card. Entry of the code would alert the point of sale system or other sponsor computer networked to (or coinciding with) sponsor remote computer 120 to signal to advertisement system server 110 that the discount / coupon has been redeemed. In this manner, the advertisement system application 210 can perform analysis on the success or failure of certain promotions. This success and failure may be measured in terms of sponsor profitability, utilization rates, or various other metrics. Sponsors may also be able to track additional sales made simultaneously with the use of the coupons or discount cards that can be attributed to traffic driven to the sponsor by the system 100. The results of the analysis can be used to help the sponsor or the host select and price future offers to be made through the system 100.

Though in most cases the coupons or stored value cards received for the purchase of a discount space will only be good for purchase of goods or services from the sponsor, this is not necessarily the case. In some embodiments, the system host might sponsor the discount board, and might offer coupons or stored value cards good at various different retailers. Where the sponsor is trying to focus purchasers on its goods, the advertisement system application 210 might provide hyperlinks around the discount area associated with websites where the sponsor's products or services may be purchased, and through which the coupons or stored value cards may be redeemed. The sponsored good associated with a discount board, and any interim awards that might be offered, could be goods or services offered by the sponsor, coupons or stored value cards of significantly greater value than those sold in association with discount spaces, or goods or services wholly unrelated to the sponsor. Generally, though not necessarily, discount boards offering coupons feature a sponsored good of higher value that is funded through the sale of the coupons, whereas discount boards offering discount cards feature a sponsored good of lesser value donated by the sponsor.

One variation among different discount boards is whether users can see the coupons or discount cards prior to the purchase. In some cases, all of the coupons or discount cards on a given discount board will be the same, in which case it makes no difference. However, in other cases, some discount spaces may offer coupons or discount cards of greater value than others. In still other cases, some discount spaces may offer coupons or discount cards good at different retailers, or for different goods or services. Where the coupon or discount card offered for the discount space is visible prior to the transaction, users can seek out what they want and make a purchase. Where they cannot, a further element of chance is involved, and a potential desire to trade or sell coupons or stored value cards within application system 210, such as discussed in association with FIG. 16 above, may develop.

Though typically the multiple party advertisement facilitation system 100 is operated over the Internet and can pair users from wide geographies, the system 100 may also be tailored to provide a local solution to accommodate the needs of some sponsors. For example, system visitors on a national or international level are not likely to be interested in a sponsored service that must be rendered in a particular geography. Therefore, the system is able to route users to particular local offers and opportunities for participation, even if those users do not have a profile or have not logged in. By using a standard Internet protocol address detection technique known in the art, the system application 200 can detect the general location of where the visitor is accessing the Internet. If it happens to be an area in or near Chicago for example, the application 200 might present sponsored goods and services specific to that area. A good example might be a dinner theatre package at a particular single-location venue in Chicago. The sponsor behind such a sponsored service would generally need to identify that it wanted to operate a geographically limited discount board. Visitors with IP addresses in or near Chicago would see the discount board relating to the dinner theatre, or an advertisement for it, when accessing advertisement system server 110, but visitors with IP addresses from other areas would not.

A related feature in local embodiments is for system application 200 to display a map (using content brought in from www.mapquest.com or a similar website) somewhere around the perimeter of the discount board identifying the location of the sponsor, or where the sponsored service is to be rendered. In some embodiments, users may be offered the opportunity to override regional preferences, or even request opportunities from sponsors in a particular location. In this manner, they might obtain goods or services in an area to which they are traveling, or perhaps something for a geographically distant friend or relative.

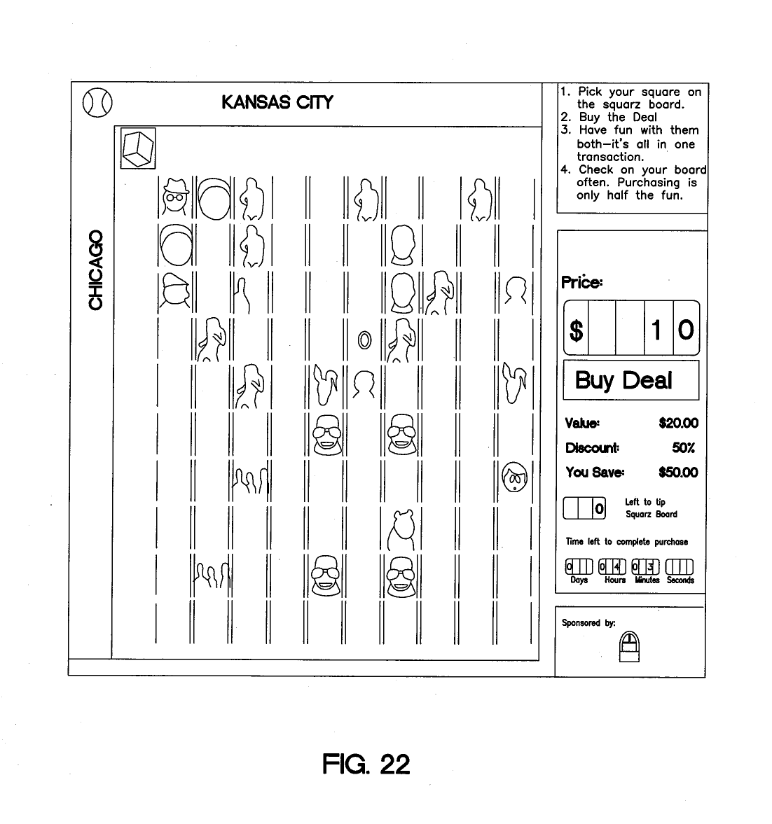

FIGS. 22-25 provide exemplary screen shots of the advertising system application 200 in operation, according to a particular embodiment. In FIG. 22, a user has located a discount board of interest, associated with the future event of a Chicago vs. Kansas City game set to begin in a little more than a day. Several discount spaces have already been purchased and adorned with GameFace content. A discount is being offered at ten dollars that has a market value of twenty dollars if used as instructed. More specifics about the discount and the sponsor would be available by scrolling up or down on the webpage. In exchange for purchasing the discount at the assigned price, a discount space is assigned (or selected) and content is submitted.

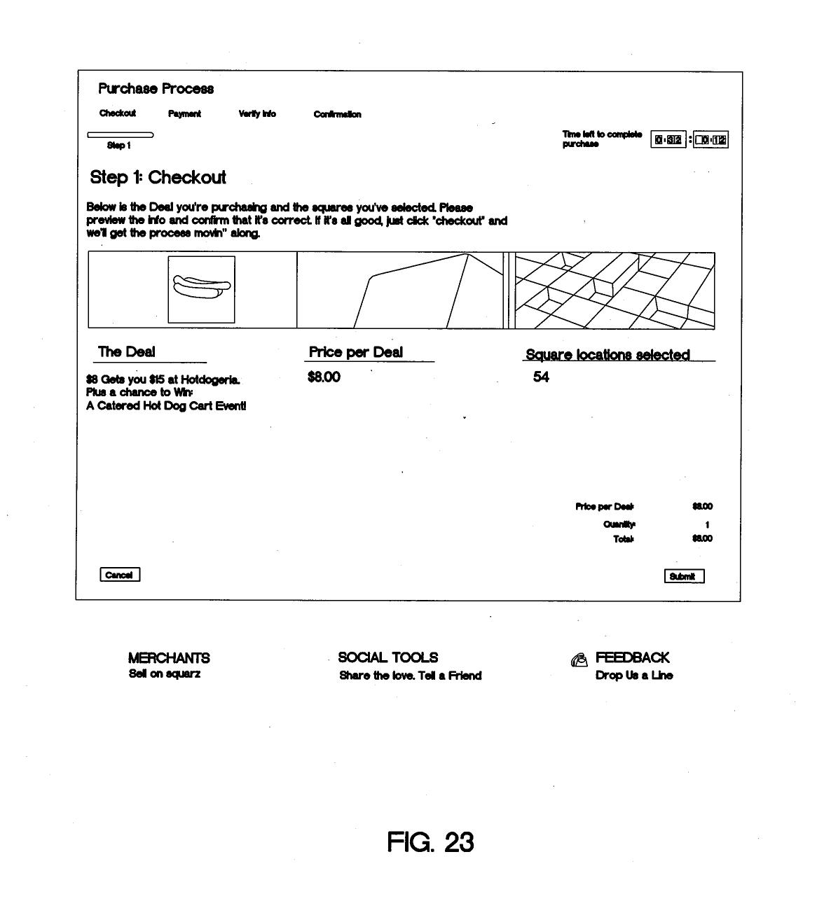

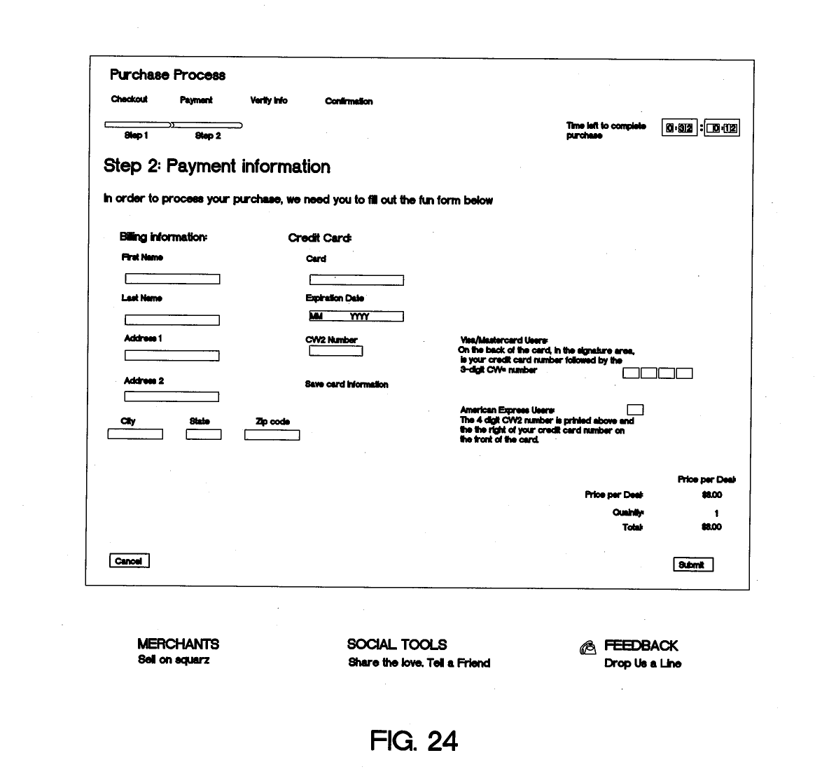

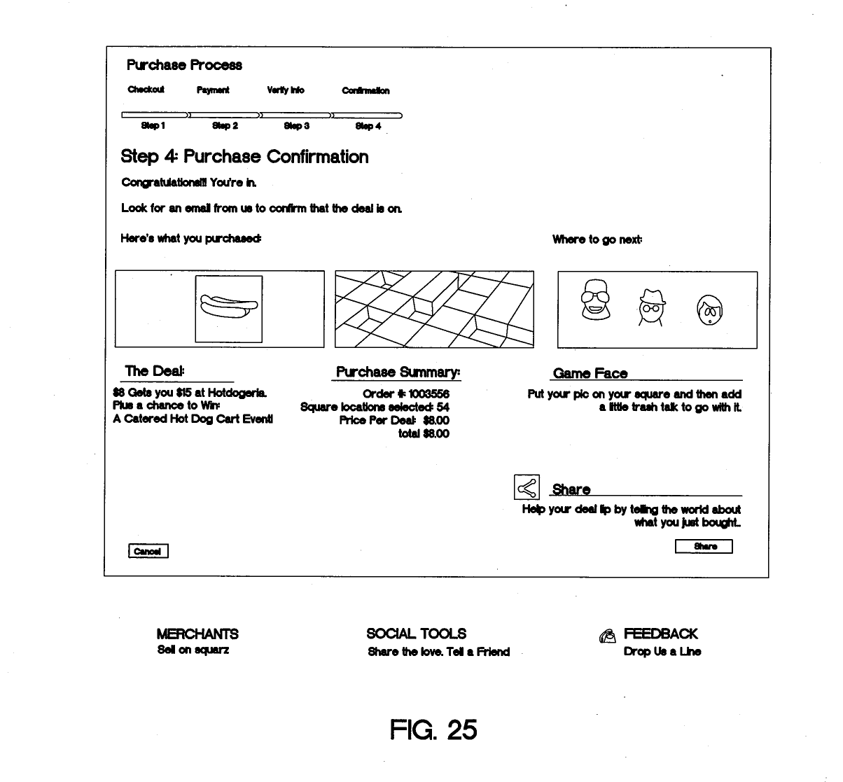

In FIG. 23, a visitor has identified to system server 110 a desire to purchase a discount, and has been taken to a further instructional display. In this case, an $8 purchase results in coupon worth $15 at a particular restaurant (the sponsor). Of course, the coupon will expire in time and may have other limitations attached, such as what it can be used to purchase. The coupon purchase also allows the user to pick a square and get a chance to receive a much larger value item for free. In this case, 54 discount spaces have already been purchased. By selecting checkout, the user is directed to a payment screen, as shown in FIG. 24. There is nothing unique here, however, payment screens may vary across other embodiments. In some cases, frequent users may have “accounts” associated with the system 100 that can hold balances. Finally, in FIG. 25, the user is provided with a confirmation of his purchase, an order number, and a link to proceed to selection of a particular discount space.

Accordingly, it should now be clear how multiple party advertisement facilitation system 100 can be used by sponsors, participant advertisers and secondary advertisers in a variety of ways to present advertisements and conduct promotional campaigns in an environment that encourages viewership and participation. Any process descriptions or blocks in the figures, such as FIGS. 4-8, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described exemplary embodiments of the present invention, and particularly any “preferred” embodiments, are possible examples of implementations, merely set forth for a clear understanding of the principles of the invention. Many other variations and modifications may be made to the above-described embodiments of the invention without substantially departing from the spirit and principles of the invention. All such modifications are intended to be included herein within the scope of this disclosure and the present invention and protected by the following claims.

1. A method of advertising retail goods or service through an interactive software application operated through a network by a host server, the method comprising the steps of: associating a retail offer with each of a plurality of discount spaces within a discount board;
associating a sponsored good or service with the discount board;
associating a future event with the discount board, wherein the future event will produce an alphanumeric result for use by the host server to determine a resultant discount space;
transmitting the discount board over the network for allowing a user to view the discount board remotely through a user computer;
receiving at the host server a request from the user to purchase a first discount space from among the plurality of discount spaces within the discount board;
assigning the first discount space and the retail offer associated with that space to the user; and,
awarding the sponsored good or service to the user if the host server determines the first discount space to be the resultant discount space based on the alphanumeric result produced by the future event.

2. The method of claim 1, wherein the retail offer is a coupon valid for goods and services priced at a first amount, and wherein the first amount is greater than the purchase price of the first discount space.

3. The method of claim 2, wherein the coupon expires if not redeemed within a fixed period of time.

4. The method of claim 1, wherein the retail offer is a good or service of lesser value than the sponsored good or service.

5. The method of claim 2, further comprising the step of receiving to the host server notice that the coupon has been redeemed.

6. The method of claim 1, further comprising the step of automatically directing the user to the discount board based on at least one characteristic of the user from the group of characteristics consisting of the user's age, sex, geographic location, and purchasing history.

7. The method of claim 1, further comprising the step of directing the user to the discount board based on search criteria submitted to the host server by the user.

8. The method of claim 1, further comprising the steps of:
receiving to the host server media content from the user; and, displaying the media content on the first discount space within the discount board.

9. (canceled)

10. (canceled)

11. (canceled)

12. (canceled)

13. An advertisement system for offering retail discounts to users through sales of discount spaces within a discount board comprising a plurality of discount spaces, the system comprising:
a computer memory for receiving from a plurality of remote computers and storing sponsored good or service data identifying a sponsored good or service for association with the discount board, discount data associated with discounts to be offered in return for the purchase of a discount space, and price data reflecting a first price to be charged for the discount space; and,
a processor for associating the sponsored good or service data with the discount board, for associated the discount data and price data with each discount space, for transmitting to a remote computer the discount board, for determining, based on an outcome of a future event, a resultant discount space from among the plurality of discount spaces, and for identifying the user having selected and purchased the resultant discount space for the purpose of distributing the sponsored good or service;
wherein the discount board is defined by first locations along a first axis and second locations along a second axis, and a retail discount is provided in exchange for the purchase of a discount space at the first price.

14. The advertisement system of claim 13, wherein the retail discount is associated with a discount amount that is greater than the first price.

15. The advertisement system of claim 14, wherein the discount amount is variable and reduces to an amount equal to the first price after a predetermined amount of time.

16. (canceled)

17. (canceled)

18. (canceled)

19. (canceled)

20. (canceled)

21. (canceled)

22. (canceled)

23. A computer readable medium for enticing advertising viewership comprising:
logic for receiving from a sponsor sponsored good or service data identifying a sponsored good or service, at least one future event, and a retail price of the sponsored good or service;
logic for constructing an advertising area associated with the sponsored good or service data, the advertising area comprised of a plurality of advertising spaces defined by first locations along a first axis and second locations along a second axis, wherein the number of first locations and second locations are determined by the at least one future event;
logic for posting a digital image of the advertising area on a computer network for viewing through computers connected to the network;
logic for receiving, through the network, participant advertiser data from at least one participant advertiser remote computer, the participant advertiser data comprising advertising content to be displayed on one or more advertising spaces identified by the participant advertiser data;
logic for updating the digital image of the advertising area to reflect the advertising content from the at least one participant advertiser remote computer on the one or more advertising spaces identified by the participant advertiser data;
logic for determining a resultant advertising space from among the plurality of advertising spaces based on an alphanumeric result of the future event or random number generation; and
logic for distribution of the sponsored good or service to the participant advertiser having selected and purchased the resultant advertising space.

24. The computer readable medium of claim 23, further comprising:
logic for receiving from a secondary advertiser computer secondary advertising data for generating advertising revenue associated with the advertising area;
logic for determining a calculated secondary advertising revenue amount based on the revenue generated from the secondary advertising; and
logic for crediting the calculated secondary advertising revenue amount to at least one of the participant advertisers.

25. The computer readable medium of claim 23, wherein the sponsored good or service is a product or service sold at retail by the sponsor.

26. The computer readable medium of claim 25, wherein the sponsored good or service data further identifies a buy now price at which the product or service may be directly purchased through the network, and wherein the computer readable medium further comprises logic for displaying instructions for purchasing the product or service adjacent to the advertising area on the computer network at the identified buy now price.

27. The computer readable medium of claim 23, wherein the sponsored good or service data further identifies an advertising space price which a participant advertiser must pay in order for the computer readable medium to update the digital image of the advertising area with the advertising content comprised within the participant advertiser data.

28. (canceled)

29. (canceled)

30. (canceled)

31. (canceled)

32. (canceled)

33. The computer readable medium of claim 23, wherein the one or more advertising spaces identified by the participant advertiser data comprises multiple, contiguous advertising spaces forming a block of advertising spaces, wherein the advertising content is extended over the block of advertising spaces.

34. The computer readable medium of claim 23, wherein the advertising content comprised within the participant advertiser data further comprises instructions for embedding a hyperlink in the advertising content, said hyperlink identifying a network address associated with the participant advertiser.

35. The computer readable medium of claim 27, wherein the sponsor is a charitable organization.

36. The computer readable medium of claim 35, further comprising logic for computing a tax-deductible value associated with the advertising space price.
